(19) United States
(12) Patent Application Publication
(10) Pub. No.: US 2026/0015531 A1
(43) Pub. Date: Jan. 15, 2026

(54) ADHESIVE SHEET, ADHESIVE SHEET WITH RELEASE FILM, LAMINATED BODY FOR IMAGE DISPLAY DEVICE, IMAGE DISPLAY DEVICE, AND ADHESIVE SHEET FOR COMPONENT FOR IMAGE DISPLAY DEVICE

(71) Applicant: MITSUBISHI CHEMICAL CORPORATION, Tokyo (JP)

(72) Inventors: Satoshi TASHIRO, Tokyo (JP); Jouji WAKAYAMA, Tokyo (JP); Shinya FUKUDA, Tokyo (JP)

(73) Assignee: MITSUBISHI CHEMICAL CORPORATION, Tokyo (JP)

(21) Appl. No.: 19/331,942

(22) Filed: Sep. 17, 2025

Related U.S. Application Data
(63) Continuation of application No. PCT/JP2024/011178, filed on Mar. 22, 2024.

(30) Foreign Application Priority Data
Mar. 27, 2023 (JP) 2023-050518

(51) Int. Cl. C09J 151/00; C09J 7/38

(52) U.S. Cl. CPC C09J 151/003; C09J 7/38; C09J 2203/326; C09J 2301/302; C09J 2301/408; C09J 2301/416; C09J 2451/00

(57) ABSTRACT

The present disclosure provides an adhesive sheet including an acrylic adhesive layer.

### RELATED APPLICATIONS

This application is a continuation of International Application No. PCT/JP2024/011178, filed on Mar. 22, 2024, which claims priority to Japanese Patent Application No. 2023-050518 which was filed on Mar. 27, 2023, the entire contents of each of which are herein incorporated by reference.

### TECHNICAL FIELD

The present disclosure relates to an adhesive sheet, an adhesive sheet with a release film, a laminate for an image display device, an image display device, and an adhesive sheet for an image display device constituent member.

### BACKGROUND ART

To improve visibility of an image display device, a gap between an image display panel such as a liquid crystal display (LCD), a plasma display (PDP), or an electroluminescence display (ELD) and a protection panel or a touch panel member disposed on the front face side (viewing side) thereof is filled with a resin such as a pressure-sensitive adhesive or an adhesive, thereby suppressing reflection of incident light or emitted light from a displayed image at an air layer interface.

For example, JP 4971529 B discloses a method for producing a constituent laminate for an image display device having a configuration in which an image display device constituent member is laminated on at least one side of a transparent double-sided adhesive sheet, the method including bonding an adhesive sheet primarily crosslinked by ultraviolet rays to an image display device constituent member, and then irradiating the adhesive sheet with ultraviolet rays through the image display device constituent member to secondarily cure the adhesive sheet.

In addition, JP 6062740 B discloses a pressure-sensitive adhesive sheet containing a (meth)acrylic copolymer having an ultraviolet crosslinkable moiety as an adhesive sheet useful for a display and a touch panel.

### RELATED ART DOCUMENT

### Patent Document

Patent Document 1: JP 4971529 B
Patent Document 2: JP 6062740 B

### SUMMARY

### Technical Problem

As a requirement for an image display device, there is a demand for enlarging an effective display region as much as possible without changing an outer dimension, that is, a strong demand for narrowing a frame.

Thus, there is a demand for an adhesive sheet for bonding an image display constituent member, which can be bonded without air bubbles up to the peripheral edge near the end face of the adhesive sheet, which is located immediately below a concealing portion and cannot be visually recognized in the related art.

In addition, in recent years, high designability has been required for an image display device, and the shape of a surface protection panel on the front face side is changing from a flat shape to a shape in which the end face or the corner portion is bent, a design in which the entire display portion is curved, or the like. In a case of a curved member or a member having a bent end face or corner portion, air bubbles are more likely to be generated in the peripheral edge than in a case of a flat member.

The adhesive sheets of Patent Documents 1 and 2 are intended to study a laminated structure using a known image display device constituent member, and bonding reliability near the peripheral edge portion of the adhesive sheet, which is located immediately below the concealing portion and cannot be visually recognized in the related art, is not considered.

In addition, the flexible adhesive sheet in the related art is likely to have a crushed end face and overflow of an adhesive (adhesive layer), and as a solution to this problem, it is desired to provide a certain degree of hardness. However, when the sheet is made too hard, there is a problem in that air bubbles are likely to be generated in the peripheral edge.

Accordingly, for an image display device in which the frame is being narrowed, there is required an adhesive sheet that has a suitable hardness and still has superior bonding reliability at the peripheral edge portion, which is a trade-off characteristic.

Under such a background, the present disclosure provides an adhesive sheet, an adhesive sheet with a release film, a laminate for an image display device, an image display device, and an adhesive sheet for an image display device constituent member, which have a higher level of bonding reliability than in the related art.

### Solution to Problem

That is, the present disclosure has the following aspects.

[1] An adhesive sheet comprising: an acrylic adhesive layer is formed of an adhesive composition comprising an acrylic polymer (A),
wherein a stress relaxation rate is 0.25 or more, and
wherein the stress relaxation rate is calculated by the following equation (I) from an initial modulus of elasticity (G′(0)) at 0.1 seconds after application of a strain of 25% to the acrylic adhesive layer at a temperature of 70° C. and a relaxation modulus of elasticity (G′(300)) at 300 seconds after application of a strain of 25% to the acrylic adhesive layer at a temperature of 70° C.:

$$Stress relaxation rate = ( {G}^{′} ( 300 ) / {G}^{′} ( 0 ) ) . \qquad ( I )$$

[2] An adhesive sheet comprising: an acrylic adhesive layer, wherein the acrylic adhesive layer is a cured reaction product of a syrup composition comprising an alkyl (meth)acrylate (a1) having an alkyl group with 3 to 30 carbon atoms, and a hydroxyl group-containing monomer (a2),
wherein a stress relaxation rate is 0.25 or more, and
wherein the stress relaxation rate is calculated by the following equation (I) from an initial modulus of elasticity (G′(0)) at 0.1 seconds after application of a strain of 25% to the acrylic adhesive layer at a temperature of 70° C. and a relaxation modulus of elasticity (G′(300)) at 300 seconds after application of a strain of 25% to the acrylic adhesive layer at a temperature of 70° C.:

$$Stress relaxation rate = ( {G}^{′} ( 300 ) / {G}^{′} ( 0 ) ) . \qquad ( I )$$

[3] The adhesive sheet according to [1] or [2], wherein the initial modulus of elasticity (G′(0)) is from 5 to 100 kPa.

[4] The adhesive sheet according to any one of [1] to [3], wherein the relaxation modulus of elasticity (G′(300)) is from 1.3 to 100 kPa.

[5] The adhesive sheet according to any one of [1] to [4], wherein the adhesive sheet has a gel fraction of 30 to 95%.

[6] The adhesive sheet according to any one of [1] to [5], wherein a storage modulus of elasticity at a temperature of 25° C. (G′(25° C.)) as obtained by dynamic viscoelasticity measurement in a shear mode at a frequency of 1 Hz is 80 kPa or more.

[7] The adhesive sheet according to any one of [1] to [6], wherein a glass transition temperature (Tg) defined by a maximum value of Tan δ as obtained by dynamic viscoelasticity measurement in a shear mode at a frequency of 1 Hz is −20° C. or higher.

[8] The adhesive sheet according to any one of [1] to [7], wherein the adhesive sheet is a monolayer.

[9] The adhesive sheet according to [1], wherein the adhesive composition comprises a crosslinking agent (B) and a photoinitiator (C).

[10] The adhesive sheet according to [9], wherein the photoinitiator (C) comprises a photoinitiator (c1) having a radically polymerizable functional group having a carbon-carbon double bond and a structure that generates a radical in a molecule, and a hydrogen abstraction type photoinitiator (c2) other than the photoinitiator (c1).

[11] An adhesive sheet with a release film, the adhesive sheet comprising: the adhesive sheet according to any one of [1] to [10]; and a release film laminated on the adhesive sheet.

[12]A laminate for an image display device, the laminate comprising: two image display device constituent members; and the adhesive sheet according to any one of [1] to [10], is interposed between the two image display device constituent members, wherein one of the two image display device constituent members is a surface protection panel, and the other is a member formed of any one or a combination of two or more of the group consisting of a touch sensor film, an image display panel, a color filter, a polarizing element, and a retardation film.

[13] The laminate for an image display device according to [12], wherein the surface protection panel comprises a concealing portion having a frame shape in a peripheral edge thereof, and includes a portion in which a frame width of the concealing portion is 3 mm or less.

[14] The laminate for an image display device according to [12] or

[13], wherein the laminate is fixed in a state of having a curved face shape.

[15] An image display device comprising the laminate for an image display device according to any one of [12] to [14].

[16] An adhesive sheet for an image display device constituent member, the adhesive sheet comprising the adhesive sheet according to any one of [1] to [10].

### Advantageous Effects

The adhesive sheet according to the present disclosure can be bonded without air bubbles up to the peripheral edge near the end face of the adhesive sheet, which is located immediately below a concealing portion and cannot be visually recognized in the related art. Accordingly, the adhesive sheet can be suitably used as an adhesive sheet used for an image display device, particularly an image display device having a narrow frame design or a frameless design.

### DESCRIPTION OF EMBODIMENTS

Hereinafter, an example of an embodiment of the present disclosure will be described in detail. However, the present disclosure is not limited to the embodiment described below.

Note that as used herein, the term “film” conceptually encompasses a sheet, a film, and a tape.

In addition, when a “panel” is expressed in such a manner of an image display panel, a protection panel, or the like, it encompasses a plate, a sheet, and a film.

As used herein, when “x to y” (x and y are any numbers) is described, it encompasses the meaning of “x or more and y or less” and the meaning of “preferably more than x” or “preferably less than y” unless otherwise specified.

In addition, when “x or more” (x is any number) is described, it encompasses the meaning of “preferably larger than x” unless otherwise specified, and when “y or less” (y is any number) is described, it encompasses the meaning of “preferably smaller than y” unless otherwise specified.

Further, “x and/or y (x and y are any configurations)” means at least one of x or y, and means three ways of x only, y only, and x and y.

As used herein, “(meth)acryl” means both acryl and methacryl, “(meth)acrylate” means both acrylate and methacrylate, and “(meth)acryloyl” means both acryloyl and methacryloyl.

Furthermore, as used herein, a main component means a component that greatly affects characteristics of the material, and the content of the component is usually 50 mass % or more, preferably 70 mass % or more, and particularly preferably 90 mass % or more of the entire materials.

In the present specification, with regard to numerical ranges described in stages, an upper limit value or a lower limit value of a numerical range of a certain stage can be combined in any way with an upper limit value or a lower limit value of a numerical range of another stage. In addition, in a numerical range described in the present specification, the upper limit value or the lower limit value of the numerical range can be replaced with a value shown in Examples.

### Adhesive Sheet

An adhesive sheet according to an example of an embodiment of the present disclosure (hereinafter referred to as “the present adhesive sheet 1”) is an adhesive sheet including an acrylic adhesive layer formed of an adhesive composition containing an acrylic polymer (A), in which a stress relaxation rate is 0.25 or more, where the stress relaxation rate is calculated by the following equation (I) from an initial modulus of elasticity (G′(0)) at 0.1 seconds after application of a strain of 25% to the acrylic adhesive layer at a temperature of 70° C. and a relaxation modulus of elasticity (G′(300)) at 300 seconds after application of a strain of 25% to the acrylic adhesive layer at a temperature of 70° C.

$$Stress relaxation rate = ( {G}^{′} ( 300 ) / {G}^{′} ( 0 ) ) \qquad ( I )$$

An adhesive sheet according to an example of a second embodiment of the present disclosure (hereinafter referred to as “the present adhesive sheet 2”) is an adhesive sheet including an acrylic adhesive layer, in which the acrylic adhesive layer is a cured reaction product formed of a syrup composition including an alkyl (meth)acrylate (a1) having an alkyl group with 3 or more carbon atoms, and a hydroxyl group-containing monomer (a2), and a stress relaxation rate (X0) is 0.25 or more, where the stress relaxation rate (X0) is calculated by the following equation (I) from an initial modulus of elasticity (G₀′(0)) at 0.1 seconds after application of a strain of 25% to the acrylic adhesive layer at a temperature of 70° C. and a relaxation modulus of elasticity (G₀′(300)) at 300 seconds after application of a strain of 25% to the acrylic adhesive layer at a temperature of 70° C.

$$Stress relaxation rate ( X 0 ) = ( G {0}^{′} ( 300 ) / G {0}^{′} ( 0 ) ) \qquad ( I )$$

Hereinafter, the present adhesive sheet 1 and the present adhesive sheet 2 will be described. The present adhesive sheet 1 and the present adhesive sheet 2 are sometimes collectively referred to as “the present adhesive sheet”.

The present adhesive sheet satisfies the following requirement (1).

### Requirement (1)

A stress relaxation rate calculated by the following equation (I) from an initial modulus of elasticity (G′(0)) at 0.1 seconds after application of a strain of 25% to the acrylic adhesive layer at a temperature of 70° C. and a relaxation modulus of elasticity (G′(300)) at 300 seconds after application of a strain of 25% to the acrylic adhesive layer at a temperature of 70° C. is 0.25 or more.

$$Stress relaxation rate = ( {G}^{′} ( 300 ) / {G}^{′} ( 0 ) ) \qquad ( I )$$

The adhesive sheet satisfying the requirement (1) has a high cohesive force, and thus air incorporated at the time of bonding a member is less likely to form air bubbles. As a result, it is possible to reduce or eliminate air bubbles in the peripheral edge portion of the adhesive sheet.

In a laminate requiring precise bonding such as a laminate for an image display device, when members are bonded, finish bonding is generally performed by a heating and pressurizing treatment using an autoclave.

After the autoclave process is completed or after the product is started to be used, air bubbles may be generated in the peripheral edge portion. One of the main causes of generation of such air bubbles is considered to be that air present in an autoclave furnace infiltrates between the bonding member and the adhesive sheet due to elevated pressure in the autoclave furnace during the bonding process.

In the related art, the peripheral end portion of the display is covered with a concealing layer such as a print or a bezel, and thus, such air bubbles do not appear on the appearance. However, in recent years, the peripheral end portion has been narrowed due to the demand for a narrower frame and a frameless design of a display, and improvement in foaming resistance at the peripheral edge portion of the adhesive sheet is strongly desired.

From the viewpoint of improving the foaming resistance at the peripheral edge portion of the adhesive sheet, the stress relaxation rate is preferably 0.3 or more, more preferably 0.35 or more, even more preferably 0.4 or more, among them, preferably 0.45 or more, and particularly preferably 0.55 or more.

On the other hand, from the viewpoint of obtaining an appropriate stress relaxation property, the stress relaxation rate is preferably 0.9 or less, more preferably 0.8 or less, and even more preferably 0.7 or less, although the upper limit is usually 1. The lower and upper limits of the stress relaxation rate can be combined in any way.

The stress relaxation rate is determined as follows.

An initial modulus of elasticity (G′(0)) and a relaxation modulus of elasticity (G′(300)) are measured by a method described below, and the obtained values are substituted into the following equation (I) to calculate the stress relaxation rate.

$$Stress relaxation rate ( X 0 ) = ( {G}^{′} ( 300 ) / {G}^{′} ( 0 ) ) \qquad ( I )$$

Examples of the method for adjusting the stress relaxation rate include a method of adjusting a composition and a molecular weight of the acrylic polymer (A), and types and contents of a crosslinking agent (B) and a photoinitiator (C), and a method of adjusting an irradiation amount of an active energy ray. However, the method is not limited to these methods.

The present adhesive sheet preferably further satisfies the following requirement (2).

### Requirement (2)

An initial modulus of elasticity (G′(0)) at 0.1 seconds after application of a strain of 25% to the acrylic adhesive layer at a temperature of 70° C. is from 5 to 100 kPa.

The adhesive sheet satisfying the requirement (2) has an appropriate cohesive force and thus is excellent in handleability. Meanwhile, there is a tendency that the peripheral edge portion of the adhesive sheet is hardly crushed at the time of bonding a member, and adhesive overflow at the end portion can be reduced or eliminated.

From the viewpoint of reducing the adhesive overflow, the initial modulus of elasticity (G′(0)) is preferably 10 kPa or more, more preferably 15 kPa or more, and even more preferably 20 kPa or more.

In addition, in a case where an adherend has irregularities, from the viewpoint of filling irregularities on the surface at the time of bonding, the initial modulus of elasticity (G′(0)) is preferably 60 kPa or less, more preferably 50 kPa or less, and even more preferably 40 kPa or less. The lower and upper limits of the initial modulus of elasticity (G′(0)) in the requirement (2) can be combined in any way.

The initial modulus of elasticity (G′(0)) is measured, for example, as follows.

The adhesive sheet is repeatedly laminated to adjust the thickness to 0.7 to 1.2 mm (e.g., about 0.8 mm), and punched out to have a diameter of 8 mm. A rheometer is used to apply a strain of 25% to the obtained sample at 70° C., and after 0.1 seconds, the modulus of elasticity is read.

Note that in the measurement of the initial modulus of elasticity (G′(0)), it is necessary to avoid fluctuation of a measurement result due to the influence of a measuring jig. The initial modulus of elasticity (G′(0)) is measured after adjusting the thickness to a range of 0.7 to 1.2 mm, and this allows the initial modulus of elasticity (G′(0)) to be accurately measured without being affected by a measuring jig.

Note that the phrase “adjusting the thickness to 0.7 to 1.2 mm” means that, in a case where the thickness of the adhesive sheet as a measurement sample is out of this range, the thickness of the measurement sample is adjusted to this range by, for example, laminating several sheets. The same applies to a case where the thickness of the measurement sample is specified in another test.

Examples of the method for adjusting the initial modulus of elasticity (G′(0)) include a method of adjusting a composition and a molecular weight of the acrylic polymer (A), and types and added amounts of the crosslinking agent (B) and the photoinitiator (C), and a method of adjusting an irradiation amount of an active energy ray. However, the method is not limited to these methods.

The present adhesive sheet preferably further satisfies the following requirement (3).

### Requirement (3)

A relaxation modulus of elasticity (G′(300)) at 300 seconds after application of a strain of 25% to the acrylic adhesive layer at a temperature of 70° C. is from 1.3 to 100 kPa.

The adhesive sheet satisfying the requirement (3) has an appropriate cohesive force and thus is excellent in handleability. Meanwhile, there is a tendency that the peripheral edge portion of the adhesive sheet is hardly crushed at the time of bonding a member, and adhesive overflow at the end portion can be reduced or eliminated.

From the viewpoint of reducing the adhesive overflow, the relaxation modulus of elasticity (G′(300)) is preferably 2 kPa or more, more preferably 5 kPa or more, and even more preferably 10 kPa or more.

In addition, from the viewpoint of maintaining appropriate flexibility and ensuring wettability to an adherend, the relaxation modulus of elasticity (G′(300)) is preferably 80 kPa or less, more preferably 70 kPa or less, even more preferably 60 kPa or less, and particularly preferably 50 kPa or less. The lower and upper limits of the relaxation modulus of elasticity (G′(300)) can be combined in any way.

The relaxation modulus of elasticity (G′(300)) is measured, for example, as follows.

The adhesive sheet is repeatedly laminated to adjust the thickness to 0.7 to 1.2 mm (e.g., about 0.8 mm), and punched out to have a diameter of 8 mm. A rheometer is used to apply a strain of 25% to the obtained sample at 70° C., and after 300 seconds, the modulus of elasticity is read.

Examples of the method for adjusting the relaxation modulus of elasticity (G′(300)) include a method of adjusting a composition and a molecular weight of the acrylic polymer (A), and types and contents of the crosslinking agent (B) and the photoinitiator (C), and a method of adjusting an irradiation amount of an active energy ray. However, the method is not limited to these methods.

The present adhesive sheet preferably further satisfies the following requirement (4).

### Requirement (4)

A shear storage modulus of elasticity at 25° C. (G′(25° C.)) obtained by dynamic viscoelasticity measurement in a shear mode at a frequency of 1 Hz is 80 kPa or more.

The adhesive sheet satisfying the requirement (4) tends to be excellent in handleability and adhesive overflow resistance.

From such a viewpoint, the shear storage modulus of elasticity at 25° C. (G′(25° C.)) is preferably 100 kPa or more, among these, preferably 150 kPa or more, more preferably 200 kPa or more, even more preferably 250 kPa or more, particularly preferably 300 kPa or more, and further preferably 400 kPa or more. On the other hand, from the viewpoint of ensuring the stress relaxation property of the adhesive sheet, the shear storage modulus of elasticity at 25° C. (G′(25° C.)) is preferably 1000 kPa or less, more preferably 900 kPa or less, and even more preferably 800 kPa or less. The lower and upper limits of the shear storage modulus of elasticity at 25° C. (G′(25° C.)) can be combined in any way.

The shear storage modulus of elasticity at 25° C. (G′(25° C.)) is measured, for example, as follows.

The adhesive sheet is repeatedly laminated to adjust the thickness to 0.7 to 1.2 mm (e.g., 0.8 mm), and then punched out to have a circular shape having a diameter of 8 mm. A rheometer is used to perform dynamic viscoelasticity measurement on the obtained sample under conditions of a measuring jig: a parallel plate with a diameter of 8 mm, a frequency: 1 Hz, a measurement temperature: −50 to 150° C., and a temperature rise rate: 5° C./min, and a value of the shear storage modulus of elasticity at 25° C. (G′(25° C.)) is read.

Examples of the method for adjusting the shear storage modulus of elasticity at 25° C. (G′(25° C.)) to the above range include a method of adjusting a composition and a molecular weight of the acrylic polymer (A), and types and contents of the crosslinking agent (B) and the photoinitiator (C), and a method of adjusting an irradiation amount of an active energy ray. However, the method is not limited to these methods.

The present adhesive sheet preferably further satisfies the following requirement (5).

### Requirement (5)

A glass transition temperature (Tg) defined by the maximum value of Tan δ as obtained by dynamic viscoelasticity measurement in a shear mode at a frequency of 1 Hz is −25° C. or higher.

The adhesive sheet satisfying the requirement (5) tends to be excellent in handleability and adhesive overflow resistance.

From such a viewpoint, the glass transition temperature (Tg) is preferably −20° C. or higher, more preferably −15° C. or higher, even more preferably −10° C. or higher, particularly preferably −5° C. or higher, and most preferably 0° C. or higher. On the other hand, the upper limit is preferably 60° C. or lower, more preferably 50° C. or lower, and even more preferably 40° C. or lower, from the viewpoint of obtaining appropriate flexibility and stress relaxation property. The lower and upper limits of the glass transition temperature (Tg) can be combined in any way.

The glass transition temperature (Tg) is obtained by reading a temperature at which a loss tangent (Tan δ) is a maximum value, that is, a peak temperature, from dynamic viscoelasticity spectrum data in the shear mode obtained by the same measurement method as that of the shear storage modulus of elasticity at 25° C. (G′(25° C.)) described above.

Note that in the viscoelasticity spectrum, the “peak temperature” in a case where a plurality of maximum value is present is a temperature at which the maximum value is the largest.

Examples of a method for adjusting the glass transition temperature (Tg) to the above range include a method of adjusting a composition and a molecular weight of the acrylic polymer (A), and types and contents of the crosslinking agent (B) and the photoinitiator (C), and a method of adjusting an irradiation amount of an active energy ray. However, the method is not limited to these methods.

The present adhesive sheet preferably further satisfies the following requirement (6).

### Requirement (6)

The adhesive sheet has a gel fraction of 30 to 90%.

The adhesive sheet satisfying the requirement (6) tends to have an appropriate cohesive force and be excellent in handleability and shape stability.

From the viewpoint of obtaining an appropriate cohesive force, the gel fraction is preferably 35% or more, more preferably 40% or more, and even more preferably 45% or more. On the other hand, from the viewpoint of obtaining a stress relaxation property, the gel fraction is preferably 90% or less, more preferably 87% or less, and even more preferably 85% or less. The lower and upper limits of the gel fraction can be combined in any way.

Measurement of the gel fraction is performed, for example, as follows.

The present adhesive sheet whose mass has been measured in advance and a 150 mesh SUS wire mesh are prepared. Next, the present adhesive sheet is wrapped with the SUS wire mesh and immersed in ethyl acetate at 23° C. for 24 hours. Thereafter, the resultant is dried at 70° C. for 4.5 hours, and the mass of the resultant is measured together with the SUS wire mesh. The mass of the SUS wire mesh is subtracted from the measured mass to determine the mass of the undissolved present adhesive sheet remaining in the wire mesh (mass after immersion). Then, a percentage of the mass of the undissolved present adhesive sheet remaining in the wire mesh (mass after immersion) to the mass of the present adhesive sheet before immersion in ethyl acetate (mass before immersion) is calculated as a gel fraction (%).

Examples of the method for adjusting the gel fraction to the above range include a method of adjusting a composition and a molecular weight of the acrylic polymer (A), and types and contents of the crosslinking agent (B) and the photoinitiator (C), and a method of adjusting an irradiation amount of an active energy ray. However, the method is not limited to these methods.

The present adhesive sheet preferably further satisfies the following requirement (7).

### Requirement (7)

An adhesive force of the acrylic adhesive layer to soda-lime glass at a temperature of 23° C. and a peeling rate of 60 mm/min is 2 N/cm or more.

The end face of the adhesive sheet satisfying the requirement (7) is not peeled off, and excellent bonding reliability at the peripheral edge portion can be achieved. From such a viewpoint, the adhesive force is preferably 2 N/cm or more, more preferably 4 N/cm or more, even more preferably 6 N/cm or more, and particularly preferably 10 N/cm or more. Note that the upper limit of the adhesive force is usually 50 N/cm, and preferably 30 N/cm.

The adhesive force is measured, for example, as follows.

A polyethylene terephthalate (PET) film having a thickness of 100 μm as a backing film and the acrylic adhesive layer of the adhesive sheet are bonded to each other, and the other face is roll-pressed to soda-lime glass to obtain a bonded product. Thereafter, the bonded product is subjected to an autoclaving treatment (temperature: 60° C., gauge pressure: 0.2 MPa, 20 minutes) for finish bonding, and the resultant is used as a sample for measuring the adhesive force. When the sample is used to perform peeling at a peeling angle of 180° and a peeling rate of 60 mm/min under an environment of a temperature of 23° C. and a humidity of 50% RH, the peeling force (N/cm) is defined as the adhesive force.

The present adhesive sheet preferably further satisfies the following requirement (8).

### Requirement (8)

When the adhesive sheet is press-bonded to an adherend, an average value of adhesive overflow distances of the adhesive sheet at each side thereof is 200 μm or less.

There is a tendency that the end face of the adhesive sheet satisfying the requirement (8) is hardly crushed, and excellent bonding reliability in the peripheral edge portion can be achieved. From such a viewpoint, the adhesive overflow distance is preferably 150 μm or less, more preferably 100 μm or less, and even more preferably 80 μm or less. Note that the adhesive overflow distance is usually 0 μm, that is, no adhesive preferably overflows.

The adhesive overflow distance is measured, for example, as follows.

The adhesive sheet is cut into a piece of 10 mm×10 mm, and then is press-bonded to soda-lime glass at a temperature of 23° C., a gauge pressure of 0.4 MPa, and a pressing time of 60 seconds using a vacuum bonding machine. The distance between a position of an end portion before press-bonding and a position of an end portion after press-bonding was measured at the center of each side of the adhesive sheet, and the average value of four sides was taken as the adhesive overflow distance (μm).

### Present Adhesive Sheet 1

The present adhesive sheet 1 has an acrylic adhesive layer formed of an adhesive composition containing an acrylic polymer (A).

The adhesive composition preferably further contains a crosslinking agent (B) and a photoinitiator (C).

The adhesive composition may further contain an additional component besides the acrylic polymer (A), the crosslinking agent (B), and the photoinitiator (C).

In a case where the adhesive composition has active energy ray curability, the present adhesive sheet 1 is typically an adhesive sheet obtained by curing an adhesive composition containing the acrylic polymer (A).

Hereinafter, each component contained in the adhesive composition will be described in detail.

### Acrylic Polymer (A)

Examples of the acrylic polymer (A) include homopolymers of alkyl (meth)acrylates and copolymers obtained by polymerizing monomer components copolymerizable with the alkyl (meth)acrylate.

Among these, it is preferable that the acrylic polymer (A) contains two or more copolymerization components, and at least one of the copolymerization components is an alkyl (meth)acrylate (a1) having an alkyl group with 3 to 30 carbon atoms (hereinafter, sometimes referred to as “alkyl (meth)acrylate (a1)”).

More specific examples of the acrylic polymer (A) include copolymers of copolymerization components including an alkyl (meth)acrylate (a1) and, for example, at least one copolymerizable monomer (hereinafter, sometimes referred to as “copolymerizable monomer (a2) to (a10)”) selected from the group consisting of a hydroxyl group-containing monomer (a2), a nitrogen-containing monomer (a3), a carboxy group-containing monomer (a4), an epoxy group-containing monomer (a5), a vinyl monomer (a6), an alkyl (meth)acrylate monomer (a7) having an alkyl group with 1 or 2 carbon atoms, an alicyclic monomer (a8), a macromonomer (a9), and another copolymerizable monomer (a10), which are copolymerizable with the alkyl (meth)acrylate (a1).

Among them, it is preferable to contain the hydroxyl group-containing monomer (a2) and/or the nitrogen-containing monomer (a3) as the copolymerization components from the viewpoint of being able to achieve all of corrosion resistance, adhesiveness, and resistance to wet heat whitening in a case where the adherend contains a component having corrosion properties such as a metal, and it is particularly preferable to contain the hydroxyl group-containing monomer (a2) and the nitrogen-containing monomer (a3) from the viewpoint of further increasing cohesiveness. In addition, in a case where the adherend contains a component having corrosion properties such as a metal, it is preferable that the copolymerization components do not contain the carboxy group-containing monomer (a4) from the viewpoint of corrosion resistance characteristics.

Such an acrylic polymer (A) usually has constituent units derived from the copolymerizable monomers (a2) to (a10) contained in the copolymerization components, in addition to a constituent unit derived from the alkyl (meth)acrylate (a1) having an alkyl group with 3 to 30 carbon atoms.

### Alkyl (Meth)acrylate (a1)

The alkyl (meth)acrylate (a1) is a linear or branched alkyl (meth)acrylate having an alkyl group with 3 to 30 carbon atoms, and is represented by the following formula (Chem. 1).

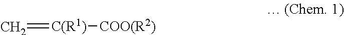

(In Chem. 1, R¹ represents a hydrogen atom or a methyl group, and R² represents a linear or branched alkyl group having 3 to 30 carbon atoms.)

Examples of the alkyl (meth)acrylate represented by the formula (Chem. 1) include linear alkyl (meth)acrylates such as n-propyl (meth)acrylate, i-propyl (meth)acrylate, n-butyl (meth)acrylate, n-pentyl (meth)acrylate, n-hexyl (meth)acrylate, n-heptyl (meth)acrylate, n-octyl (meth)acrylate, n-nonyl (meth)acrylate, n-decyl (meth)acrylate, undecyl (meth)acrylate, lauryl (meth)acrylate, n-tridecyl (meth)acrylate, n-tetradecyl (meth)acrylate, cetyl (meth)acrylate, stearyl (meth)acrylate, icosyl (meth)acrylate, heneicosyl (meth)acrylate, and behenyl (meth)acrylate; and branched alkyl (meth)acrylates such as sec-butyl (meth)acrylate, isobutyl (meth)acrylate, t-butyl (meth)acrylate, isopentyl (meth)acrylate, neopentyl (meth)acrylate, 2-ethylhexyl (meth)acrylate, isooctyl (meth)acrylate, isononyl (meth)acrylate, isodecyl (meth)acrylate, isobornyl (meth)acrylate, isostearyl (meth)acrylate, isoicosyl (meth)acrylate, butyloctyl (meth)acrylate, isomyristyl (meth)acrylate, isocetyl (meth)acrylate, hexyldecyl (meth)acrylate, isostearyl (meth)acrylate, octyldecyl (meth)acrylate, octyldodecyl (meth)acrylate, and isobehenyl (meth)acrylate. One of these may be used alone or two or more thereof may be used in combination.

Among these, linear alkyl (meth)acrylates are preferred from the viewpoint of obtaining flexibility. In addition, from the viewpoint of balancing adhesiveness and flexibility, linear alkyl (meth)acrylates having an alkyl group with 3 to 20 carbon atoms, further 5 to 18 carbon atoms, particularly 6 to 16 carbon atoms, and especially 7 to 14 carbon atoms are preferable, and for example, n-butyl (meth)acrylate, n-pentyl (meth)acrylate, n-hexyl (meth)acrylate, n-octyl (meth)acrylate, n-nonyl (meth)acrylate, decyl (meth)acrylate, and lauryl (meth)acrylate are preferable.

On the other hand, among these, from the viewpoint that a hydrogen abstraction reaction described below is likely to occur during irradiation with an active energy ray, and as a result, a crosslinked structure can be efficiently formed, a branched alkyl (meth)acrylate, that is, an alkyl (meth)acrylate containing a tertiary carbon atom in the alkyl group, is preferable. Among these, branched alkyl (meth)acrylates having an alkyl group with 3 to 20 carbon atoms, further 5 to 18 carbon atoms, particularly 6 to 16 carbon atoms, and especially 7 to 14 carbon atoms are preferable, for example, sec-butyl (meth)acrylate, isobutyl (meth)acrylate, t-butyl (meth)acrylate, isopentyl (meth)acrylate, neopentyl (meth)acrylate, 2-ethylhexyl (meth)acrylate, isooctyl (meth)acrylate, isononyl (meth)acrylate, isodecyl (meth)acrylate, and isobornyl (meth)acrylate are preferable, and 2-ethylhexyl (meth)acrylate and isobornyl (meth)acrylate are particularly preferable.

The proportion of the constituent unit derived from the alkyl (meth)acrylate (a1) to the acrylic polymer (A) is usually from 5 to 95 mass %, preferably from 10 to 90 mass %, more preferably from 15 to 85 mass %, and particularly preferably from 20 to 80 mass %. When the proportion of the constituent unit derived from the alkyl (meth)acrylate (a1) is the lower limit value or more, flexibility tends to be excellent, and in a case where the adherend has irregularities, irregularity followability tends to be excellent. When the proportion is the upper limit value or less, the effect of a copolymerizable monomer described below is easily obtained, and the adhesive force and the cohesive force tend to be excellent.

### Hydroxyl Group-Containing Monomer (a2)

Examples of the hydroxyl group-containing monomer (a2) include hydroxyalkyl (meth)acrylates such as 2-hydroxyethyl (meth)acrylate, 4-hydroxybutyl (meth)acrylate, 5-hydroxypentyl (meth)acrylate, 6-hydroxyhexyl (meth)acrylate, and 8-hydroxyoctyl (meth)acrylate; caprolactone-modified hydroxy (meth)acrylates such as caprolactone-modified 2-hydroxyethyl (meth)acrylate; (meth)acrylates having an oxyalkylene structure such as diethylene glycol (meth)acrylate, polyethylene glycol (meth)acrylate, polypropylene glycol (meth)acrylate, polytetramethylene glycol (meth)acrylate, and polyoxyethylene polyoxypropylene glycol (meth)acrylate; primary hydroxyl group-containing (meth)acrylates such as 2-acryloyloxyethyl-2-hydroxyethylphthalate; secondary hydroxyl group-containing (meth)acrylates such as 2-hydroxypropyl (meth)acrylate, 2-hydroxybutyl (meth)acrylate, and 3-chloro-2-hydroxypropyl (meth)acrylate; tertiary hydroxyl group-containing (meth)acrylates such as 2,2-dimethyl-2-hydroxyethyl (meth)acrylate; and vinyl ethers such as 2-hydroxyethyl vinyl ether, diethylene glycol monovinyl ether, and 4-hydroxybutyl vinyl ether. One of these may be used alone or two or more thereof may be used in combination.

The hydroxyl group-containing monomer (a2) can improve the adhesive force of the adhesive sheet and can suppress the wet heat whitening. In addition, in a case where the adhesive composition contains a thermal crosslinking agent described below, a crosslinking reaction site is formed.

Among the hydroxyl group-containing monomers (a2), hydroxyl group-containing monomers having a hydroxyalkyl group with 1 to 10 carbon atoms, further 1 to 6 carbon atoms, and especially 2 to 4 carbon atoms such as 2-hydroxyethyl (meth)acrylate, 4-hydroxybutyl (meth)acrylate, 2-hydroxypropyl (meth)acrylate, 2-hydroxyethyl vinyl ether, diethylene glycol monovinyl ether, and 4-hydroxybutyl vinyl ether are preferable, and primary hydroxyl group-containing (meth)acrylates such as 2-hydroxyethyl (meth)acrylate and 4-hydroxybutyl (meth)acrylate are particularly preferable.

In a case where the acrylic polymer (A) has a constituent unit derived from the hydroxyl group-containing monomer (a2), the content thereof is usually 3 to 30 mass %, preferably 5 to 25 mass %, and particularly preferably 7 to 20 mass %, with respect to the acrylic polymer (A), from the viewpoint of imparting an adhesive force and resistance to wet heat whitening.

### Nitrogen-Containing Monomer (a3)

Examples of the nitrogen-containing monomer (a3) include an amino group-containing monomer, an amide group-containing monomer, an isocyanate group-containing monomer, and (meth)acrylonitrile. One of these may be used alone or two or more thereof may be used in combination. The nitrogen-containing monomer (a3) can improve the cohesive force of the adhesive sheet and can suppress the wet heat whitening. In addition, in a case where a hydrogen abstraction type photoinitiator described below is used, the acrylic polymer (A) preferably has a constituent unit derived from the nitrogen-containing monomer (a3). The nitrogen-containing monomer (a3) has an effect of promoting a hydrogen abstraction reaction in a case where the hydrogen abstraction type photoinitiator described below is used.

Examples of the amino group-containing monomer include primary amino group-containing (meth)acrylates such as aminomethyl (meth)acrylate and aminoethyl (meth)acrylate; secondary amino group-containing (meth)acrylates such as t-butylaminoethyl (meth)acrylate and t-butylaminopropyl (meth)acrylate; tertiary amino group-containing (meth)acrylates such as ethylaminoethyl (meth)acrylate, dimethylaminoethyl (meth)acrylate, diethylaminoethyl (meth)acrylate, dimethylaminopropyl (meth)acrylate, diethylaminopropyl (meth)acrylate, and dimethylaminopropylacrylamide; and monomers such as N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, (meth)acryloylmorpholine, N-vinylacetamide, and N-vinylcaprolactam.

Examples of the amide group-containing monomer include (meth)acrylamides; N-alkyl (meth)acrylamides such as N-methyl (meth)acrylamide, N-ethyl (meth)acrylamide, N-propyl (meth)acrylamide, N-n-butyl (meth)acrylamide, diacetone (meth)acrylamide, and N,N′-methylenebis(meth)acrylamide; N,N-dialkyl (meth)acrylamides such as N,N-dimethyl (meth)acrylamide, N,N-diethyl (meth)acrylamide, N,N-dipropyl (meth)acrylamide, N,N-ethylmethyl acrylamide, and N,N-diallyl (meth)acrylamide; hydroxyalkyl (meth)acrylamides such as N-hydroxymethyl (meth)acrylamide and N-hydroxyethyl (meth)acrylamide; alkoxyalkyl (meth)acrylamides such as N-methoxymethyl (meth)acrylamide and N-(n-butoxymethyl) (meth)acrylamide; and maleimides or derivatives thereof. Among these, (meth)acrylamide is preferable.

Examples of the isocyanate group-containing monomer include 2-(meth)acryloyloxyethyl isocyanate and alkylene oxide adducts thereof. The isocyanate group may be protected with a blocking agent such as methylethyl ketone oxime, 3,5-dimethylpyrazole, 1,2,4-triazole, or diethyl malonate.

Among these, from the viewpoint of having a sensitizing action of a hydrogen abstraction reaction by a hydrogen abstraction type photoinitiator described below, and as a result being able to efficiently form a crosslinked structure, those having a tertiary nitrogen atom are preferable, and tertiary amino group-containing (meth)acrylates, N,N-dialkyl (meth)acrylamide, N-vinylpyrrolidone, acryloylmorpholine, and the like are particularly preferable.

In a case where the acrylic polymer (A) has a constituent unit derived from the nitrogen-containing monomer (a3), the content thereof is usually 0.1 to 15 mass %, preferably 0.5 to 13 mass %, particularly preferably 1 to 10 mass %, and especially preferably 2 to 7 mass %, with respect to the acrylic polymer (A), from the viewpoint of imparting a cohesive force and resistance to wet heat whitening.

### Carboxy Group-Containing Monomer (a4)

Examples of the carboxy group-containing monomer (a4) include (meth)acrylic acid, 2-(meth)acryloyloxyethylhexahydrophthalic acid, 2-(meth)acryloyloxypropylhexahydrophthalic acid, 2-(meth)acryloyloxyethylphthalic acid, 2-(meth)acryloyloxypropylphthalic acid, 2-(meth)acryloyloxyethylmaleic acid, 2-(meth)acryloyloxypropylmaleic acid, 2-(meth)acryloyloxyethylsuccinic acid, 2-(meth)acryloyloxypropylsuccinic acid, crotonic acid, fumaric acid, maleic acid, and itaconic acid. One of these may be used alone or two or more thereof may be used in combination.

In a case where the acrylic polymer (A) has a constituent unit derived from the carboxy group-containing monomer (a4), the content thereof is usually 0.1 to 15 mass %, preferably 0.3 to 13 mass %, more preferably 0.5 to 10 mass %, and particularly preferably 1 to 6 mass %, with respect to the acrylic polymer (A).

### Epoxy Group-Containing Monomer (a5)

Examples of the epoxy group-containing monomer (a5) include glycidyl (meth)acrylate, methylglycidyl (meth)acrylate, 3,4-epoxycyclohexylmethyl (meth)acrylate, and 4-hydroxybutyl (meth)acrylate glycidyl ether. One of these may be used alone or two or more thereof may be used in combination.

In a case where the acrylic polymer (A) has a constituent unit derived from the epoxy group-containing monomer (a5), the content thereof is usually 0.1 to 15 mass %, preferably 0.3 to 13 mass %, more preferably 0.5 to 10 mass %, and particularly preferably 1 to 6 mass %, with respect to the acrylic polymer (A).

### Vinyl Monomer (a6)

Examples of the vinyl monomer (a6) include a compound having a vinyl group in the molecule. Examples of such a compound include vinyl ester monomers such as vinyl acetate, vinyl propionate, vinyl laurate, and vinyl stearate, and aromatic vinyl monomers such as styrene, chlorostyrene, chloromethylstyrene, α-methylstyrene, and other substituted styrenes. One of these may be used alone or two or more thereof may be used in combination.

In a case where the acrylic polymer (A) has a constituent moiety derived from the vinyl monomer (a6), the content thereof is usually 1 to 40 mass %, preferably 5 to 35 mass %, more preferably 8 to 30 mass %, and particularly preferably 10 to 25 mass %, with respect to the acrylic polymer (A), from the viewpoint of imparting a cohesive force to the adhesive sheet.

Alkyl (Meth)Acrylate Monomer (a7) Having Alkyl Group with 1 or 2 Carbon Atoms

Examples of the alkyl (meth)acrylate monomer (a7) having an alkyl group with 1 or 2 carbon atoms include methyl (meth)acrylate and ethyl (meth)acrylate. One of these may be used alone or two or more thereof may be used in combination.

In a case where the acrylic polymer (A) has a constituent unit derived from the alkyl (meth)acrylate monomer (a7), the content thereof is usually 1 to 60 mass %, preferably 5 to 55 mass %, particularly preferably 10 to 50 mass %, and especially preferably 15 to 45 mass %, with respect to the acrylic polymer (A), from the viewpoint of imparting a cohesive force to the adhesive sheet.

### Alicyclic Monomer (a8)

Examples of the alicyclic monomer (a8) include cyclohexyl (meth)acrylate, 3,3,5-trimethylcyclohexyl (meth)acrylate, isobornyl (meth)acrylate, dicyclopentanyl (meth)acrylate, dicyclopentenyloxyethyl (meth)acrylate, t-butylcyclohexyl (meth)acrylate, and adamantyl (meth)acrylate. One of these may be used alone or two or more thereof may be used in combination.

In a case where the acrylic polymer (A) has a constituent unit derived from the alicyclic monomer (a8), the content thereof is usually 0.1 to 15 mass %, preferably 0.5 to 13 mass %, particularly preferably 1 to 10 mass %, and especially preferably 2 to 7 mass %, with respect to the acrylic polymer (A), from the viewpoint of imparting a cohesive force to the adhesive sheet.

### Macromonomer (a9)

The macromonomer (a9) is a monomer that can easily increase the number of carbon atoms in the side chain of the acrylic polymer (A), for example, to 20 or more, when formed into the acrylic polymer (A) by polymerization.

When the macromonomer (a9) is used as a copolymerization component, the acrylic polymer (A) can be a graft copolymer having a constituent moiety (segment) derived from the macromonomer (a9). In addition, characteristics of the main chain and the side chain of the graft copolymer can be changed by changing the blending ratio of the macromonomer (a9) and the other monomers.

The macromonomer (a9) has a radically polymerizable functional group or a functional group such as a hydroxy group, an isocyanate group, an epoxy group, a carboxy group, an amino group, an amide group, or a thiol group. The macromonomer (a9) may have only one of these or two or more thereof in combination.

Among them, the macromonomer (a9) preferably has a radically polymerizable functional group that is copolymerizable with another monomer. The radically polymerizable functional group may be contained alone or in combination of two or more, but one radically polymerizable functional group is particularly preferably contained.

In addition, also in a case where the macromonomer (a9) has a functional group, one or more functional groups may be contained, but one functional group is particularly preferably contained.

The macromonomer (a9) preferably has a skeleton component formed of an acrylic polymer or a vinyl-based polymer.

Examples of the skeleton component of the macromonomer (a9) include the alkyl (meth)acrylate (a1) having an alkyl group with 3 to 30 carbon atoms, the vinyl monomer (a6), the alkyl (meth)acrylate monomer (a7) having an alkyl group with 1 or 2 carbon atoms, and the alicyclic monomer (a8). One of these may be used alone or two or more thereof may be used in combination.

Among them, it is preferable to use, as the skeleton component, an alkyl (meth)acrylate having an alkyl group with 1 to 8 carbon atoms, an alicyclic monomer, or an aromatic monomer such as styrene, from the viewpoint of obtaining an adhesive sheet excelling in cohesive force.

On the other hand, use of an alkyl (meth)acrylate having 9 to 30 carbon atoms is preferred in that an adhesive sheet excelling in flexibility can be obtained.

The number average molecular weight of the macromonomer (a9) is preferably 1,000 or more and 40,000 or less, among them, more preferably 1,500 or more and 20,000 or less, and among them, even more preferably 2,000 or more and 15,000 or less.

The number average molecular weight of the macromonomer (a9) is a value calibrated with standard polystyrene as measured by gel permeation chromatography (GPC).

As the macromonomer (a9), a commonly produced macromonomer (for example, macromonomer available from Toagosei Co., Ltd.) can be appropriately used.

In a case where the acrylic polymer (A) has a constituent unit derived from the macromonomer (a9), the content thereof is usually 1 to 30 mass %, preferably 3 to 20 mass %, and more preferably 5 to 18 mass %, with respect to the acrylic polymer (A). When the content is the lower limit value or more, a force of phase separation between a segment containing the constituent unit derived from the macromonomer (a9) and a segment formed of another constituent unit becomes strong, and the cohesive force of the adhesive sheet tends to be more excellent. When the content is the upper limit value or less, the phase separation structure is easily collapsed during bonding, and the irregularity followability tends to be more excellent.

Another Copolymerizable Monomer (a10)

Examples of the other copolymerizable monomer (a10) include (meth)acrylates having an alkoxyalkylene glycol skeleton such as methoxydiethylene glycol (meth)acrylate, methoxypolyethylene glycol (meth)acrylate, butoxypolyethylene glycol (meth)acrylate, methoxypolypropylene glycol (meth)acrylate, butoxypolypropylene glycol (meth)acrylate, methoxypolytetramethylene glycol (meth)acrylate, butoxypolytetramethylene glycol (meth)acrylate, methoxypolyoxyethylene polyoxypropylene glycol (meth)acrylate, and butoxypolyoxyethylene polyoxypropylene glycol (meth)acrylate; aromatic (meth)acrylates such as phenyl (meth)acrylate, benzyl (meth)acrylate, phenoxyethyl (meth)acrylate, phenyldiethylene glycol (meth)acrylate, phenoxypolyethylene glycol (meth)acrylate, phenoxypolyethylene glycol-polypropylene glycol-(meth)acrylate, and nonylphenolethyleneoxide adduct (meth)acrylate; (meth)acrylates having a benzophenone structure such as 4-acryloyloxybenzophenone, 4-acryloyloxyethoxybenzophenone, 4-acryloyloxy-4′-methoxybenzophenone, 4-acryloyloxyethoxy-4′-methoxybenzophenone, 4-acryloyloxy-4′-bromobenzophenone, 4-acryloyloxyethoxy-4′-bromobenzophenone, 4-methacryloyloxybenzophenone, 4-methacryloyloxyethoxybenzophenone, 4-methacryloyloxy-4′-methoxybenzophenone, 4-methacryloyloxyethoxy-4′-methoxybenzophenone, 4-methacryloyloxy-4′-bromobenzophenone, 4-methacryloyloxyethoxy-4′-bromobenzophenone, and mixtures thereof; heterocycle-containing (meth)acrylates such as tetrahydrofurfuryl (meth)acrylate; and macromonomers. One of these may be used alone or two or more thereof may be used in combination.

In a case where the acrylic polymer (A) has a constituent unit derived from the other copolymerizable monomer (a10), the content thereof is usually 1 to 30 mass %, preferably 3 to 20 mass %, and more preferably 5 to 15 mass %, with respect to the acrylic polymer (A).

The method for producing the acrylic polymer (A) is not particularly limited. For example, copolymerization components including the alkyl (meth)acrylate (a1) and, if necessary, at least one selected from the group consisting of the copolymerizable monomers (a2) to (a10) are polymerized.

Examples of the polymerization method include known methods in the related art such as solution polymerization, suspension polymerization, bulk polymerization, and emulsion polymerization, and among these, solution polymerization is preferable in that an acrylic resin can be produced safely and stably with any monomer composition.

Thus, the acrylic polymer (A) can be obtained.

The acrylic polymer (A) may have a photoactive moiety, for example, a polymerizable carbon-carbon double bond group, introduced into a side chain thereof. This can increase crosslinking efficiency of the adhesive composition, whereby the adhesive composition can be crosslinked in a shorter time to increase productivity.

Examples of the method for introducing a polymerizable carbon-carbon double bond group into a side chain of the acrylic polymer (A) include a method in which a copolymer containing functional group-containing ethylenically unsaturated monomers such as the above-described hydroxyl group-containing monomer (a2), nitrogen atom-containing monomer (a3), carboxy group-containing monomer (a4), and epoxy group-containing monomer (a5) is prepared, and then the copolymer and a compound having a functional group reactive with these functional groups and a polymerizable carbon-carbon double bond group are subjected to a condensation or addition reaction while maintaining activity of the polymerizable carbon-carbon double bond group.

Examples of the combination of these functional groups include an epoxy group (glycidyl group) and a carboxy group, an amino group and a carboxy group, an amino group and an isocyanate group, an epoxy group (glycidyl group) and an amino group, a hydroxyl group and an epoxy group, and a hydroxyl group and an isocyanate group. Among these combinations of functional groups, a combination of a hydroxyl group and an isocyanate group is preferable from the viewpoint of ease of reaction control. Among them, a combination in which the copolymer has a hydroxyl group and the compound has an isocyanate group is suitable.

Examples of the isocyanate compound having a polymerizable carbon-carbon double bond group include the above-described 2-(meth)acryloyloxyethyl isocyanate and alkylene oxide adducts thereof.

The content of the compound having a functional group reactive with the functional group and a polymerizable carbon-carbon double bond group is preferably 10 parts by mass or less, more preferably 5 parts by mass or less, even more preferably 1 part by mass or less, and particularly preferably 0.1 parts by mass or less, with respect to 100 parts by mass of the acrylic polymer (A), from the viewpoint of improving adhesiveness and stress relaxation property. Note that the lower limit value is usually 0 parts by mass.

The weight average molecular weight (Mw) of the acrylic polymer (A) is preferably 200000 or more, more preferably 300000 or more, and even more preferably 400000 or more, from the viewpoint of obtaining an adhesive composition having a high cohesive force.

The upper limit value of the weight average molecular weight (Mw) of the acrylic polymer (A) is preferably 1.5 million or less, more preferably 1.2 million or less, even more preferably 1.1 million or less, and especially preferably 1 million or less, from the viewpoint of handleability and uniform stirring property.

The lower and upper limits of the weight average molecular weight of the acrylic polymer (A) can be combined in any way.

The weight average molecular weight of the acrylic polymer (A) is a value calibrated with standard polystyrene as measured by gel permeation chromatography (GPC).

The acrylic polymer (A) is preferably a main component of the adhesive composition. Here, the “main component” refers to a component having the highest content proportion among the compositional components of the adhesive composition.

Specifically, the content of the acrylic polymer (A) is preferably 50 mass % or more, more preferably 60 mass % or more, and even more preferably 70 mass % or more, based on the total mass of the adhesive composition. The upper limit is 100 mass %, but is usually preferably 99 mass % or less, more preferably 98 mass % or less, and even more preferably 97 mass % or less.

### Crosslinking Agent (B)

The adhesive composition preferably contains the crosslinking agent (B) from the viewpoint of promoting a crosslinking reaction. This allows the adhesive composition to efficiently form a crosslinked structure. In addition, when a crosslinked structure is formed in the adhesive sheet using the adhesive composition, it is possible to prevent the adhesive overflow during storage or during bonding, and to obtain good adhesiveness and cohesive force.

However, when the acrylic polymer (A) causes a hydrogen abstraction reaction by an action of the photoinitiator (C) described below or the like and the crosslinked structure can be sufficiently formed in the acrylic polymer (A) and/or between the acrylic polymers (A), the crosslinking agent (B) is not necessarily contained.

Examples of the crosslinking agent (B) include an acrylic crosslinking agent, an isocyanate-based crosslinking agent, an epoxy-based crosslinking agent, an aziridine-based crosslinking agent, a melamine-based crosslinking agent, an aldehyde-based crosslinking agent, an amine-based crosslinking agent, and a metal chelate-based crosslinking agent. One of these may be used alone or two or more thereof may be used in combination. Among these, an isocyanate-based crosslinking agent is preferably used in terms of excellent reactivity with the acrylic polymer (A). On the other hand, from the viewpoint of ease of reaction control and imparting active energy ray curability, an acrylic crosslinking agent is preferable, and among them, a polyfunctional (meth)acrylate is preferably used.

Examples of the polyfunctional (meth)acrylate include polyfunctional (meth)acrylic monomers and polyfunctional (meth)acrylic oligomers, which have two or more (meth)acryloyl groups. One of these may be used alone or two or more thereof may be used in combination.

Examples of the polyfunctional (meth)acrylic monomer include pentanediol di(meth)acrylate, hexadiol di(meth)acrylate, heptanediol di(meth)acrylate, octanediol di(meth)acrylate, nonanediol di(meth)acrylate, decanediol di(meth)acrylate, undecanediol di(meth)acrylate, dodecanediol di(meth)acrylate, 1,4-butanediol di(meth)acrylate, glycerin di(meth)acrylate, neopentylglycol di(meth)acrylate, glycerin glycidyl ether di(meth)acrylate, tricyclodecane dimethacrylate, tricyclodecane dimethanol di(meth)acrylate, bisphenol-A polyethoxy di(meth)acrylate, bisphenol-A polypropoxy di(meth)acrylate, bisphenol-F polyethoxy di(meth)acrylate, ethylene glycol di(meth)acrylate, trimethylolpropane trioxyethyl (meth)acrylate, s-caprolactone-modified tris(2-hydroxyethyl) isocyanurate tri(meth)acrylate, pentaerythritol tri(meth)acrylate, propoxylated pentaerythritol tri(meth)acrylate, ethoxylated pentaerythritol tri(meth)acrylate, pentaerythritol tetra(meth)acrylate, propoxylated pentaerythritol tetra(meth)acrylate, ethoxylated pentaerythritol tetra(meth)acrylate, dipentaerythritol hexa(meth)acrylate, polyethylene glycol di(meth)acrylate, polypropylene glycol di(meth)acrylate, polytetramethylene glycol di(meth)acrylate, tris(acryloxyethyl) isocyanurate, dipentaerythritol penta(meth)acrylate, tripentaerythritol hexa(meth)acrylate, tripentaerythiritol penta(meth)acrylate, hydroxypivalic acid neopentylglycol di(meth)acrylate, di(meth)acrylate of s-caprolactone adduct of hydroxypivalic acid neopentylglycol, trimethylolpropane tri(meth)acrylate, trimethylolpropane polyethoxy tri(meth)acrylate, and ditrimethylolpropane tetra(meth)acrylate.

Examples of the polyfunctional (meth)acrylic oligomer include polyfunctional (meth)acrylic oligomers such as polyester (meth)acrylate-based oligomers, epoxy (meth)acrylate-based oligomers, urethane (meth)acrylate-based oligomers, and polyether (meth)acrylate-based oligomers.

Among these crosslinking agents (B), polyfunctional (meth)acrylate-based monomers and oligomers having a glycol structure are preferable from the viewpoint of imparting appropriate flexibility to the cured product. From the viewpoint of imparting a cohesive force, an acrylic acid adduct of pentaerythritol or dipentaerythritol, or an alkoxylate thereof, is preferable.

In a case where the adhesive composition contains the crosslinking agent (B), the content thereof is usually 0.1 parts by mass or more, preferably 0.5 parts by mass or more, and more preferably 1 part by mass or more, with respect to 100 parts by mass of the acrylic polymer (A), from the viewpoint of being able to impart shape stability of the adhesive sheet and durability when the adhesive sheet is formed into a laminate for an image display device. The upper limit is usually 25 parts by mass or less, preferably 22 parts by mass or less, more preferably 20 parts by mass or less, and particularly preferably 18 parts by mass or less, from the viewpoint of maintaining flexibility of the adhesive sheet.

The lower and upper limits of the content of the crosslinking agent (B) can be combined in any way.

### Photoinitiator (C)

The adhesive composition preferably contains the photoinitiator (C). The photoinitiator (C) is a compound that generates a radical by an active energy ray.

The photoinitiator (C) is roughly classified into two types according to a radical generation mechanism. More specifically, the photoinitiator is roughly classified into a cleavage type photoinitiator that can generate a radical by cleaving a single bond of the photoinitiator itself, and a hydrogen abstraction type photoinitiator that can generate a radical by abstracting hydrogen from a hydrogen donor in the system by the excited initiator. One of these may be used alone or two or more thereof may be used in combination.

The cleavage type photoinitiator is preferable in that it has high photosensitivity.

On the other hand, the hydrogen abstraction type photoinitiator is preferable in that no photodecomposition product is generated, and in that the acrylic polymer (A) can be incorporated into a crosslinked structure by a hydrogen abstraction reaction.

Examples of the hydrogen abstraction type photoinitiator include intermolecular hydrogen abstraction type photoinitiators such as benzophenone, 4-methylbenzophenone, 2,4,6-trimethylbenzophenone, 4-phenylbenzophenone, 3,3′-dimethyl-4-methoxybenzophenone, methyl 2-benzoylbenzoate, 4-[(4-methylphenyl)thio]benzophenone, 4-acryloyloxybenzophenone, 4-acryloyloxyethoxybenzophenone, 4-acryloyloxy-4′-methoxybenzophenone, 4-acryloyloxyethoxy-4′-methoxybenzophenone, 4-acryloyloxy-4′-bromobenzophenone, 4-acryloyloxyethoxy-4′-bromobenzophenone, 4-methacryloyloxybenzophenone, 4-methacryloyloxyethoxybenzophenone, 4-methacryloyloxy-4′-methoxybenzophenone, 4-methacryloyloxyethoxy-4′-methoxybenzophenone, 4-methacryloyloxy-4′-bromobenzophenone, and 4-methacryloyloxyethoxy-4′-bromobenzophenone; and intramolecular hydrogen abstraction type photoinitiators such as methylbenzoylformate, methyl benzoylformate, oxyphenylacetic acid-2-(2-oxo-2-phenyl-acetoxy-ethoxy)ethyl ester, and oxyphenylacetic acid-2-(2-hydroxy-ethoxy)ethyl ester. One of these may be used alone or two or more thereof may be used in combination.

Among the intermolecular hydrogen abstraction type photoinitiators, 4-methylbenzophenone, 2,4,6-trimethylbenzophenone, and a photoinitiator (c1) having a radically polymerizable functional group having a carbon-carbon double bond and a structure that generates a radical in the molecule, for example, 4-acryloyloxybenzophenone, 4-methacryloyloxybenzophenone, 4-acryloyloxyethoxybenzophenone, 4-acryloyloxy-4′-methoxybenzophenone, 4-acryloyloxyethoxy-4′-methoxybenzophenone, and 4-methacryloyloxybenzophenone are preferable, and 4-methylbenzophenone, 2,4,6-trimethylbenzophenone, 4-methacryloyloxybenzophenone, and 4-methacryloyloxybenzophenone are more preferable. The photoinitiator (c1) having a radically polymerizable functional group having a carbon-carbon double bond and a structure that generates a radical in the molecule tends to be incorporated into the polymerization structure after photoreaction, thereby suppressing bleed-out of the photoinitiator and improving the cohesive force of the adhesive sheet.

In addition, the intramolecular hydrogen abstraction type photoinitiator is preferable in that not only the hydrogen donor in the system but also the photoinitiator itself can be a starting point of radical generation, and methylbenzoylformate is more preferable.

Examples of the cleavage type photoinitiator include 2,2-dimethoxy-1,2-diphenylethan-1-one, 1-hydroxycyclohexyl phenyl ketone, 2-hydroxy-2-methyl-1-phenyl-propan-1-one, 1-[4-(2-hydroxyethoxy)phenyl]-2-hydroxy-2-methyl-1-propan-1-one, 2-hydroxy-1-{4-[4-(2-hydroxy-2-methyl-propionyl)benzyl]phenyl}-2-methyl-propan-1-one, oligo(2-hydroxy-2-methyl-1-(4-(1-methylvinyl)phenyl)propanone), 2-benzyl-2-dimethylamino-1-(4-morpholinophenyl)butan-1-one, 2-methyl-1-[4-(methylthio)phenyl]-2-morpholinopropan-1-one, 2-(dimethylamino)-2-[(4-methylphenyl)methyl]-1-[4-(4-morpholinyl)phenyl]-1-butanone, bis(2,4,6-trimethylbenzoyl)-phenylphosphine oxide, 2,4,6-trimethylbenzoyldiphenylphosphine oxide, (2,4,6-trimethylbenzoyl)ethoxyphenylphosphine oxide, bis(2,6-dimethoxybenzoyl)2,4,4-trimethylpentylphosphine oxide, and derivatives thereof. One of these may be used alone or two or more thereof may be used in combination.

In the present disclosure, it is preferable to contain an intermolecular hydrogen abstraction type photoinitiator and an intramolecular hydrogen abstraction type photoinitiator as the photoinitiator (C), from the viewpoint of increasing the cohesive force of the adhesive sheet.

In addition, in the present disclosure, it is preferable to contain the photoinitiator (c1) having a radically polymerizable functional group having a carbon-carbon double bond and a structure that generates a radical in the molecule, and a hydrogen abstraction type photoinitiator (c2) other than the photoinitiator (c1) as the photoinitiator (C).

By using these photoinitiators (C) in combination, the cohesive force of the present adhesive sheet can be enhanced, and in a case where the present adhesive sheet has active energy ray curability, an adhesive sheet excelling in secondary curability after being bonded to an adherend can be obtained.

Note that the hydrogen abstraction type photoinitiator (c2) means a hydrogen abstraction type photoinitiator other than the photoinitiator (c1) having a radically polymerizable functional group having a carbon-carbon double bond and a structure that generates a radical in the molecule, among the hydrogen abstraction type photoinitiators described above.

Among the hydrogen abstraction type photoinitiators (c2), an intramolecular hydrogen abstraction type photoinitiator is preferable in that not only a hydrogen donor in the system but also the photoinitiator itself can be a starting point of radical generation, and methylbenzoylformate is more preferable.

In a case where the adhesive composition contains the photoinitiator (C), the content thereof is usually 10 parts by mass or less, preferably 5 parts by mass or less, more preferably 4 parts by mass or less, and particularly preferably 3 parts by mass or less, with respect to 100 parts by mass of the acrylic polymer (A). The lower limit value is usually 0.1 parts by mass. In a case where two or more types of photoinitiators (C) are used in combination, the content is the total amount of the photoinitiators (C) used.

In a case where the photoinitiator (C) contains the photoinitiator (c1) having a radically polymerizable functional group having a carbon-carbon double bond and a structure that generates a radical in the molecule and the hydrogen abstraction type photoinitiator (c2) other than the photoinitiator (c1), the content mass ratio (c2/c1) of the photoinitiator (c2) to the photoinitiator (c1) is preferably from 0.5 to 10, more preferably from 1 to 8, and even more preferably from 2 to 6.

### Monofunctional (Meth)acrylate

The adhesive composition may further contain a monofunctional (meth)acrylate having one (meth)acryloyl group, as necessary. Containing the monofunctional (meth)acrylate having one (meth)acryloyl group can increase the molecular weight between crosslinking points of the cured product, and thus the degree of freedom of movement of the molecular chain is increased, and an appropriate stress relaxation property is easily obtained.

Examples of the monofunctional (meth)acrylate include ethyl (meth)acrylate, propyl (meth)acrylate, isopropyl (meth)acrylate, butyl (meth)acrylate, isobutyl (meth)acrylate, t-butyl (meth)acrylate, amyl (meth)acrylate, isoamyl (meth)acrylate, 2-ethylhexyl (meth)acrylate, lauryl (meth)acrylate, octyl (meth)acrylate, isooctyl (meth)acrylate, decyl (meth)acrylate, isodecyl (meth)acrylate, dodecyl (meth)acrylate, isododecyl (meth)acrylate, tetradecyl (meth)acrylate, stearyl (meth)acrylate, isostearyl (meth)acrylate, behenyl (meth)acrylate, cyclopropyl (meth)acrylate, cyclobutyl (meth)acrylate, cyclopentyl (meth)acrylate, cyclohexyl (meth)acrylate, cycloheptyl (meth)acrylate, cyclooctyl (meth)acrylate, cyclononyl (meth)acrylate, cyclodecyl (meth)acrylate, isobornyl (meth)acrylate, norbornyl (meth)acrylate, adamantyl (meth)acrylate, tricyclodecanedimethanol acrylate, ethoxylated-o-phenylphenol acrylate, 2-hydroxy-o-phenylphenol propyl acrylate, methoxypolyethylene glycol (meth)acrylate, methoxypolypropylene glycol (meth)acrylate, polyethylene glycol (meth)acrylate, polypropylene glycol (meth)acrylate, phenoxyethylene glycol (meth)acrylate, phenoxydiethylene glycol (meth)acrylate, phenoxypolyethylene glycol (meth)acrylate, 2-hydroxy-o-phenylphenol propyl acrylate, 2-(meth)acryloyloxyethylsuccinic acid, 2-(meth)acryloyloxyethyltetrahydrophthalic acid, 2-(meth)acryloyloxyethylhexahydrophthalic acid, 2-(meth)acryloyloxypropylphthalic acid, 2-(meth)acryloyloxypropylhydrophthalic acid, 2-(meth)acryloyloxypropylhexahydrophthalic acid, benzyl (meth)acrylate, phenoxyethyl (meth)acrylate, phenoxyethyleneglycol (meth)acrylate, 2-naphthyl (meth)acrylate, 9-anthracenyl (meth)acrylate, 1-pyrenylmethyl (meth)acrylate, tricyclodecanedimethanol monoacrylate monocarboxylic acid, dicyclopentanyl acrylate, 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, trimethylolpropane mono(meth)acrylate, glycerin mono(meth)acrylate, pentaerythritol mono(meth)acrylate, diglycerin mono(meth)acrylate, ditrimethylolpropane mono(meth)acrylate, dipentaerythritol mono(meth)acrylate, ethoxylated trimethylolpropane mono(meth)acrylate, propoxylated trimethylolpropane mono(meth)acrylate, ethoxylated glycerin mono(meth)acrylate, propoxylated glycerin mono(meth)acrylate, ethoxylated pentaerythritol mono(meth)acrylate, propoxylated pentaerythritol mono(meth)acrylate, ethoxylated ditrimethylolpropane mono(meth)acrylate, propoxylated ditrimethylolpropane mono(meth)acrylate, alkylene oxide-modified diglycerin mono(meth)acrylate, alkylene oxide-modified dipentaerythritol mono(meth)acrylate, and the like, and in addition, monofunctional oligomers such as monofunctional urethane (meth)acrylate, monofunctional epoxy (meth)acrylate, and monofunctional polyester (meth)acrylate. One of these may be used alone or two or more thereof may be used in combination.

In a case where the monofunctional (meth)acrylate component is contained, the content thereof is preferably 1 part by mass or more, more preferably 2 parts by mass or more, and particularly preferably 5 parts by mass or more, with respect to 100 parts by mass of the acrylic polymer (A), from the viewpoint of imparting appropriate flexibility to the cured product by adjusting a crosslinking density. The upper limit value is preferably 20 parts by mass or less, more preferably 10 parts by mass or less, and particularly preferably 5 parts by mass or less.

### Additional Component

The adhesive composition may appropriately contain, as an “additional component”, various additives such as a silane coupling agent, an ultraviolet absorber, a plasticizer, a tackifier, an antioxidant, a light stabilizer, a metal deactivator, an anti-aging agent, a moisture absorbent, a rust inhibitor, and inorganic particles, as long as the effects of the present disclosure are not impaired. As necessary, a reaction catalyst such as a tertiary amine-based compound, a quaternary ammonium-based compound, or a tin laurate-based compound may be appropriately contained. One of these may be used alone or two or more thereof may be used in combination. Among these, the adhesive composition preferably contains a silane coupling agent.

### Silane Coupling Agent

The silane coupling agent is an organosilicon compound containing one or more reactive functional groups and one or more alkoxy groups bonded to a silicon atom in the structure. Examples of the reactive functional group include an epoxy group, a (meth)acryloyl group, a mercapto group, a hydroxyl group, a carboxy group, an amino group, an amide group, and an isocyanate group, and among these, an epoxy group and a mercapto group are preferable from the viewpoint of balance of durability.

The alkoxy group bonded to a silicon atom to be contained is preferably an alkoxy group having 1 to 8 carbon atoms, and particularly preferably a methoxy group or an ethoxy group, from the viewpoint of durability and storage stability. Note that the silane coupling agent may have an organic substituent other than the reactive functional group and the alkoxy group bonded to a silicon atom, such as an alkyl group or a phenyl group.

Examples of the silane coupling agent include monomer-type epoxy group-containing silane coupling agents which are silane compounds such as 3-glycidoxypropyltrimethoxysilane, 3-glycidoxypropyltriethoxysilane, 3-glycidoxypropylmethyldiethoxysilane, 3-glycidoxypropylmethyldimethoxysilane, and 2-(3,4-epoxycyclohexyl)ethyltrimethoxysilane, and oligomer-type epoxy group-containing silane coupling agents which are silane compounds obtained by hydrolysis and polycondensation of a part of the silane compounds or co-condensation of the silane compounds and alkyl group-containing silane compounds such as methyltriethoxysilane, ethyltriethoxysilane, methyltrimethoxysilane, and ethyltrimethoxysilane; monomer-type mercapto group-containing silane coupling agents which are silane compounds such as 3-mercaptopropyltrimethoxysilane, 3-mercaptopropyltriethoxysilane, γ-mercaptopropyldimethoxymethylsilane, and 3-mercaptopropylmethyldimethoxysilane, and oligomer-type mercapto group-containing silane coupling agents which are silane compounds obtained by hydrolysis and polycondensation of a part of the silane compounds, or co-condensation of the silane compounds and alkyl group-containing silane compounds such as methyltriethoxysilane, ethyltriethoxysilane, methyltrimethoxysilane, and ethyltrimethoxysilane; (meth)acryloyl group-containing silane coupling agents such as 3-acryloxypropyltrimethoxysilane, 3-methacryloxypropyltrimethoxysilane, 3-methacryloxypropylmethyldiethoxysilane, 3-methacryloxypropyltriethoxysilane, and 3-acryloxypropyltrimethoxysilane; amino group-containing silane coupling agents such as N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene)propylamine, and N-phenyl-3-aminopropyltrimethoxysilane; isocyanate group-containing silane coupling agents such as 3-isocyanatepropyltriethoxysilane; and vinyl group-containing silane coupling agents such as vinyltrimethoxysilane and vinyltriethoxysilane. One of these may be used alone or two or more thereof may be used in combination.

Among these, from the viewpoint of excellent durability, an epoxy group-containing silane coupling agent and a mercapto group-containing silane coupling agent are preferably used, and among these, an epoxy group-containing silane coupling agent is particularly preferable.

In a case where the adhesive composition contains a silane coupling agent, the content thereof is usually 0.005 to 10 parts by mass, preferably 0.01 to 5 parts by mass, and particularly preferably 0.05 to 1 part by mass, with respect to 100 parts by mass of the acrylic polymer (A). When the content is within the above range, the adhesive force and durability tend to be improved.

### Plasticizer

Examples of the plasticizer include, but are not limited to, at least one selected from the group consisting of polyisobutylene, polyisoprene, polybutadiene, amorphous polyolefins and copolymers thereof, silicone, polyacrylates, oligomeric polyurethanes, and ethylene propylene copolymers, and any combinations or mixtures thereof.

Among these, polyisobutylene is preferable.

Examples of the polyisobutylene plasticizer include, of those sold under the name OPPANOL by BASF, in particular, those selected from the OPPANOLB series.

In a case where the adhesive composition contains the plasticizer, the content thereof is not particularly limited, and is usually 0.1 to 20 parts by mass, and preferably 0.5 to 15 parts by mass, with respect to 100 parts by mass of the acrylic polymer (A).

### Tackifier

The adhesive composition may include a tackifier to improve the bonding strength of the adhesive sheet.

Examples of the tackifier include terpene resins such as polyterpenes (e.g., α-pinene-based resins, β-pinene-based resins, and limonene-based resins) and aromatic-modified polyterpene resins (e.g., phenol-modified polyterpene resins), coumarone-indene resins, petroleum-based resins such as C5-based hydrocarbon resins, C9-based hydrocarbon resins, C5/C9-based hydrocarbon resins, and dicyclopentadiene-based resins, and rosins such as modified rosins, hydrogenated rosins, polymerized rosins, and rosin esters. One of these may be used alone or two or more thereof may be used in combination.

In a case where the adhesive composition contains the tackifier, the content thereof is not particularly limited, and is usually 0.1 to 20 parts by mass, and preferably 0.5 to 15 parts by mass, with respect to 100 parts by mass of the acrylic polymer (A).

### Rust Inhibitor

The adhesive composition may contain a rust inhibitor to prevent corrosion in a case where an adherend includes a corrosive part such as a metal wiring.

Examples of the rust inhibitor include triazoles and benzotriazoles. One of these may be used alone or two or more thereof may be used in combination.

The content of the rust inhibitor in the adhesive composition is usually 0.01 to 5 parts by mass, and preferably 0.1 to 3 parts by mass or less, with respect to 100 parts by mass of the acrylic polymer (A).

### Method for Producing Present Adhesive Sheet 1

Next, a method for producing the present adhesive sheet 1 will be described.

However, the following description is an example of the method for producing the present adhesive sheet 1, and the present adhesive sheet 1 is not limited to one produced by such a production method.

The present adhesive sheet 1 can be produced by preparing an adhesive composition containing the acrylic polymer (A), preferably the crosslinking agent (B), the photoinitiator (C), additional components, and the like, as necessary, forming the adhesive composition into a sheet shape, and crosslinking, that is, polymerizing and curing the adhesive composition, followed by appropriate processing as necessary.

The adhesive composition is prepared by kneading the raw materials using a temperature-controllable kneader (e.g., a single-screw extruder, a twin-screw extruder, a planetary mixer, a twin-screw mixer, a pressurizing kneader, or the like).

Note that when various raw materials are kneaded, various additives such as a silane coupling agent and an antioxidant may be blended with a resin in advance and then supplied to the kneader, all materials may be melted and mixed in advance and then supplied, or only additives may be concentrated in a resin in advance to prepare a master batch and then supplied.

As a method for forming the adhesive composition into a sheet shape, a known method, for example, a wet lamination method, a dry lamination method, an extrusion casting method using a T-die, an extrusion lamination method, a calender method, an inflation method, injection molding, a liquid injection curing method, or the like can be adopted. Among these, in a case of producing a sheet, a wet lamination method, an extrusion casting method, and an extrusion lamination method are suitable.

Curing of the adhesive composition can be performed by irradiation with an active energy ray, and the present adhesive sheet 1 can be produced by irradiating a molded body of the adhesive composition, for example, a sheet body, with an active energy ray. Note that in addition to the irradiation with an active energy ray, the adhesive composition can be further cured by heating.

The irradiation energy, irradiation time, irradiation method, and the like of an active energy ray are not particularly limited, and it is sufficient that the photoinitiator (C) can be activated to polymerize the photoreactive component such as a (meth)acrylic acid ester compound.

In a case where a hydrogen abstraction type photoinitiator is used as the photoinitiator (C), a hydrogen abstraction reaction also occurs from the acrylic polymer (A), and the acrylic polymer (A) is incorporated into a crosslinked structure, whereby a crosslinked structure having many crosslinking points can be formed.

Accordingly, the present adhesive sheet 1 is preferably obtained by being cured using the hydrogen abstraction type photoinitiator.

Examples of the active energy ray in the active energy ray irradiation include light rays such as a far ultraviolet ray, an ultraviolet ray, a near ultraviolet ray, an infrared ray, and a visible light ray, and ionizing radiation such as an X-ray, an α-ray, a β-ray, a γ-ray, an electron beam, a proton beam, and a neutron beam. Among these, an ultraviolet ray is preferable from the viewpoint of suppression of damage to an optical device constituent member and reaction control. In addition, an ultraviolet ray is preferable from the viewpoint of curing speed, and availability, price, and the like of an irradiation device.

Examples of light sources for ultraviolet irradiation include a high-pressure mercury lamp, an ultrahigh-pressure mercury lamp, a low-pressure mercury lamp, a carbon arc lamp, a metal halide lamp, a xenon lamp, a chemical lamp, an electrodeless discharge lamp, and an LED lamp, which emit light in a wavelength region of 150 to 450 nm. Among these, a high-pressure mercury lamp, a metal halide lamp, and an LED lamp are preferably used.

The irradiation amount of the active energy ray (cumulative light quantity) is preferably 100 to 10000 mJ/cm², more preferably 200 to 8000 mJ/cm², and even more preferably 200 to 6000 mJ/cm², from the viewpoint of curing.

The present adhesive sheet 1 can also be provided as an adhesive sheet with a release film having a configuration in which a release film is laminated on one surface or both surfaces of the adhesive sheet. Among them, from the viewpoint of preventing blocking and preventing adhesion of foreign matter, it is preferable to cover both surfaces of the adhesive sheet 1 with a release film.

In a case of providing the release film on both surfaces of the present adhesive sheet 1, it is preferable to have a laminate structure in which a light release film having a relatively low peeling force and a heavy release film having a relatively high peeling force are laminated.

It is sufficient that when the adhesive sheet with a release film in which the release films are provided on both surfaces thereof is used, first, one release film (light release film) is peeled off to expose one surface of the adhesive sheet, and an image display device constituent member (referred to as a first member) is bonded to the one surface, and the other release film (heavy release film) is peeled off to expose the other surface of the adhesive sheet, and an image display device constituent member (referred to as a second member) is bonded to the other surface.

As such a release film, a known release film can be appropriately used.

As the base material of the release film, for example, a film such as a polyester film, a polyolefin film, a polycarbonate film, a polystyrene film, an acrylic film, a triacetyl cellulose film, or a fluororesin film, which is subjected to a release treatment by applying a release agent such as a silicone resin, or release paper can be appropriately selected and used.

Among these, a polyester film is preferable, a polyethylene terephthalate (PET) film is more preferable, and a biaxially stretched PET film is particularly preferable in terms of excellent transparency, mechanical strength, heat resistance, flexibility, and the like.

A release film having a release layer formed by curing a curable silicone-based release agent containing a silicone resin as a main component on the base material can be used.

The thickness of the release film is not particularly limited. Among them, from the viewpoint of, for example, processability and handleability, the thickness is preferably 10 to 250 μm, more preferably 25 to 200 μm, and even more preferably 35 to 190 μm.

In another embodiment of the method for producing the present adhesive sheet 1, the adhesive composition is dissolved in an appropriate solvent, and various coating methods can be used.

In a case of using a coating method, the present adhesive sheet 1 can be obtained by thermal curing in addition to the curing by the irradiation with an active energy ray. In the case of using a coating method, the thickness of the present adhesive sheet 1 can be adjusted by the coating thickness and the solid content concentration of a coating liquid.

The coating method may be a known method such as roll coating, die coating, gravure coating, comma coating, screen printing, or bar coating.

To produce the present adhesive sheet 1 using the coating method, for example, the present adhesive sheet 1 can be formed by dissolving the adhesive composition in a solvent, coating the release film with the dissolved adhesive composition, drying the coated adhesive composition, and curing the dried adhesive composition by irradiation with an active energy ray. Further, a release film may be laminated as necessary. In this case, the dissolved adhesive composition may be coated on a release film, dried, and cured by irradiation with an active energy ray, and then a release film may be laminated thereon, or the dissolved adhesive composition may be coated on a release film, and dried, and a release film may be laminated thereon, and then curing by irradiation with an active energy ray may be performed to form the present adhesive sheet 1.

The solvent is not particularly limited as long as it dissolves the adhesive composition, and examples thereof include ester-based solvents such as methyl acetate, ethyl acetate, butyl acetate, methyl acetoacetate, and ethyl acetoacetate; ketone-based solvents such as acetone, methyl ethyl ketone, and methyl isobutyl ketone; aromatic solvents such as toluene and xylene; and alcohol-based solvents such as methanol, ethanol, and propyl alcohol. One of these may be used alone or two or more thereof can be used in combination. Among these, ethyl acetate, acetone, methyl ethyl ketone, and toluene are preferable from the viewpoint of solubility, a drying property, cost, and the like, and ethyl acetate is particularly suitably used.

The content of the solvent is preferably 600 parts by mass or less, more preferably 500 parts by mass or less, even more preferably 400 parts by mass or less, and particularly preferably 300 parts by mass or less, with respect to 100 parts by mass of the acrylic polymer (A), from the viewpoint of the drying property. Meanwhile, the content is preferably 1 part by mass or more, more preferably 50 parts by mass or more, even more preferably 100 parts by mass or more, and particularly preferably 150 parts by mass or more.

The solvent content in the adhesive composition after drying is preferably 1 mass % or less, more preferably 0.5 mass % or less, particularly preferably 0.1 mass % or less, and most preferably 0 mass %.

The drying temperature is usually from 40 to 150° C., more preferably from 45 to 140° C., even more preferably from 50 to 130° C., and particularly preferably from 55 to 120° C. When the temperature is within the above range, the solvent can be removed efficiently and relatively safely while suppressing thermal deformation of the release film.

The drying time is usually from 1 to 30 minutes, more preferably from 3 to 25 minutes, and even more preferably from 5 to 20 minutes. When the drying time is within the above range, the solvent can be efficiently and sufficiently removed.

Examples of the drying method include drying with a dryer or a hot roll, and drying by blowing hot air to the film. Among these, a dryer is preferably used because uniform and easy drying is possible. One of these may be used alone or two or more thereof can be used in combination.

In still another embodiment of the method for producing the present adhesive sheet 1, the present adhesive sheet 1 may be produced by preparing an adhesive composition, coating the adhesive composition on an image display device constituent member described below, and curing the adhesive composition. However, the method is not limited to this method.

The present adhesive sheet 1 may be a single layer adhesive sheet consisting of only an acrylic adhesive layer formed of the adhesive composition, or may be a multilayer adhesive sheet in which another acrylic adhesive layer or another adhesive layer is laminated in a plurality of layers. Among them, the layer configuration of the present adhesive sheet 1 is preferably a monolayer, from the viewpoint of ease of production and ease of reduction in adhesive overflow.

On the other hand, the layer configuration preferably has at least two layers, more preferably has at least three layers of an outermost layer, a backmost layer, and an intermediate layer, and particularly preferably has at least three layers in which the outermost layer and the backmost layer are acrylic adhesive layers, from the viewpoint that an adhesive sheet that is less likely to be dented or indented even when a local pressure is applied can be provided.

In a case where the present adhesive sheet 1 has at least three layers of an outermost layer, a backmost layer, and an intermediate layer, it is preferred that the outermost layer and the backmost layer (hereinafter, also referred to as “front and back layers”) and the intermediate layer (a layer sandwiched between the outermost layer and the backmost layer) are formed of adhesive compositions containing acrylic polymers (A) having different compositions, particularly containing acrylic polymers (A) having different compositions as main components. Such a layer configuration is advantageous in that functions of trade-off properties such as a stress relaxation property and a shape retention property can be separated for each layer.

The outermost layer and the backmost layer may be formed of adhesive compositions containing acrylic polymers (A) having different compositions, particularly containing acrylic polymers (A) having different compositions as main components, but are preferably formed of adhesive compositions containing acrylic polymers (A) having the same composition.

In a case where the present adhesive sheet 1 has at least three layers (outermost layer/intermediate layer/backmost layer) in which the outermost layer and the backmost layer are acrylic adhesive layers, the outermost surface and the backmost surface (surfaces to be bonded to the image display device constituent members) are preferably high Tg layers. The intermediate layer sandwiched between the outermost surface and the backmost surface is preferably a low Tg layer. Furthermore, the high Tg layers used for the outermost layer and the backmost layer may have different glass transition temperatures (Tg) from each other, but the glass transition temperatures of the outermost layer and the backmost layer are preferably the same, and the outermost layer and the backmost layer are particularly preferably acrylic adhesive layers formed of the same adhesive composition.

The high Tg layer refers to a layer in which the maximum value (glass transition temperature) of the loss tangent (Tan δ) obtained by the dynamic viscoelasticity measurement in the shear mode is usually −25° C. or higher, preferably −10° C. or higher, and particularly preferably 0° C. or higher. The upper limit of the glass transition temperature of the high Tg layer is usually 60° C. or lower, preferably 40° C. or lower, more preferably 20° C. or lower, and even more preferably 10° C. or lower.

The low Tg layer refers to a layer in which the maximum value (glass transition temperature) of the loss tangent (Tan δ) obtained by the dynamic viscoelasticity measurement in the shear mode is lower than the glass transition temperature of the high Tg layer, and the glass transition temperature is usually 20° C. or lower, preferably 15° C. or lower, more preferably 10° C. or lower, even more preferably 8° C. or lower, particularly preferably 5° C. or lower, and most preferably 0° C. or lower.

The lower limit of the glass transition temperature of the low Tg layer is usually −80° C., preferably −60° C. or higher, more preferably −50° C. or higher, and even more preferably −40° C. or higher.

In addition, in a case where the present adhesive sheet 1 has at least three layers in which the outermost layer and the backmost layer are acrylic adhesive layers, the proportion of the total of thicknesses of the outermost layer and the backmost layer to the entire thickness is preferably 5 to 70%, more preferably 10 to 60%, and particularly preferably 20 to 45%. When the thicknesses of the outermost layer and the backmost layer are set within the above range, it is possible to obtain an adhesive sheet excelling in lamination suitability and durability such as foaming resistance, adhesive overflow resistance, and step absorbency at the peripheral edge portion.

The present adhesive sheet 1 thus obtained is an optically transparent adhesive sheet. Here, the phrase “optically transparent” means that the total light transmittance is 80% or more, preferably 85% or more, and more preferably 90% or more.

The haze value of the adhesive sheet is preferably 10% or less, more preferably 5% or less, and particularly preferably 3% or less.

The thickness of the present adhesive sheet is preferably from 50 to 1000 μm, more preferably from 60 to 500 μm, and particularly preferably from 75 to 300 μm.

In addition, the present adhesive sheet 1 may be embossed or formed with various irregularities (such as a conical shape, a pyramidal shape, or a hemispherical shape) as necessary. In addition, for the purpose of improving adhesiveness to various members, the surface may be subjected to various surface treatments such as a corona treatment, a plasma treatment, and a primer treatment.

### Present Adhesive Sheet 2

As described above, the present adhesive sheet 2 has an acrylic adhesive layer, and the acrylic adhesive layer is a cured reaction product formed of a syrup composition containing an alkyl (meth)acrylate (a1), and a hydroxyl group-containing monomer (a2).

Hereinafter, each component contained in the acrylic adhesive layer (syrup composition) will be described in detail.

### Alkyl (Meth)acrylate (a1)

Examples of the alkyl (meth)acrylate (a1) include the alkyl (meth)acrylate (a1) described in the present adhesive sheet 1, and the type and the like of the preferred monomer are also the same as those of the alkyl (meth)acrylate (a1) described for the present adhesive sheet 1.

The content of the constituent unit derived from the alkyl (meth)acrylate (a1) is preferably 5 to 95 mass %, more preferably 10 to 90 mass %, even more preferably 15 to 85 mass %, and particularly preferably 20 to 80 mass %, with respect to the acrylic adhesive layer (syrup composition), from the viewpoint of obtaining flexibility. When the content of the constituent unit derived from the alkyl (meth)acrylate (a1) is the lower limit value or more, foaming resistance of the peripheral edge portion at the time of bonding is excellent, and when the content is the upper limit value or less, the foaming resistance can be compatible with other physical properties such as adhesiveness, which is preferable.

### Hydroxyl Group-Containing Monomer (a2)

Examples of the hydroxyl group-containing monomer (a2) include the hydroxyl group-containing monomer (a2) described in the present adhesive sheet 1, and the types or the like of the preferred monomer are also the same as those of the hydroxyl group-containing monomer (a2) described in the present adhesive sheet 1.

The content of a constituent unit derived from the hydroxyl group-containing monomer (a2) is usually from 3 to 30 mass %, preferably from 5 to 25 mass %, and particularly preferably from 7 to 20 mass %, with respect to the acrylic adhesive layer (syrup composition).

When the content is too small, the bonding strength and the wet heat resistance when used as an adhesive tend to decrease, and when the content is too large, the self-crosslinking reaction of the adhesive layer is likely to occur, and the heat resistance tends to decrease.

The syrup composition may contain the copolymerizable monomers (a3) to (a10) described for the present adhesive sheet 1. The types and the like of these preferred monomers are the same as those described for the present adhesive sheet 1. The preferable content of the constituent unit derived from each of these copolymerizable monomers (a3) to (a10), that is, the mass ratio to the total mass of the acrylic adhesive layer (syrup composition), is the same as the mass ratio to all the constituent units of the acrylic polymer (A) described for the present adhesive sheet 1.

Further, the acrylic adhesive layer preferably contains the crosslinking agent (B) and the photoinitiator (C) described for the present adhesive sheet 1, and may contain additional components such as the silane coupling agent described for the present adhesive sheet 1.

### Crosslinking Agent (B)

In a case of using the crosslinking agent (B), the preferred compounds, physical properties, and the like are the same as those of the crosslinking agent (B) described for the present adhesive sheet 1. The content of the crosslinking agent (B) is usually from 0.1 to 20 mass %, preferably from 0.5 to 15 mass %, and particularly preferably from 1 to 10 mass %, with respect to the acrylic adhesive layer (syrup composition). When the content is the lower limit value or more, there is a tendency that curing failure is prevented, and when the content is the upper limit value or less, there is a tendency that the composition has appropriate flexibility and is excellent in stress relaxation property.

### Photoinitiator (C)

The photoinitiator is not particularly limited as long as it is the photoinitiator described for the present adhesive sheet 1, but from the viewpoint of efficiently progressing the polymerization reaction, it is preferable to include a cleavage type photoinitiator, and among the cleavage type photoinitiators described above, 2,2-dimethoxy-1,2-diphenylethan-1-one, 2-hydroxy-2-methyl-1-phenyl-propan-1-one, bis(2,4,6-trimethylbenzoyl)-phenylphosphine oxide, 2,4,6-trimethylbenzoyldiphenylphosphine oxide, and (2,4,6-trimethylbenzoyl)ethoxyphenylphosphine oxide are particularly preferable.

In addition, from the viewpoint of efficiently forming a crosslinked structure, it is preferable to include a hydrogen abstraction type photoinitiator, and benzophenone, 4-methylbenzophenone, 2,4,6-trimethylbenzophenone, 4-phenylbenzophenone, 3,3′-dimethyl-4-methoxybenzophenone, and 4-(meth)acryloyloxybenzophenone are particularly preferable.

The photoinitiator (C) may include one or more selected from the group consisting of the cleavage type photoinitiators and/or the hydrogen abstraction type photoinitiators.

In a case of using the photoinitiator (C), the content thereof is usually from 0.1 to 10 mass %, preferably from 0.5 to 6 mass %, and more preferably from 1 to 4 mass %, with respect to the acrylic adhesive layer (syrup composition). When the content is the lower limit value or more, there is a tendency that curing failure is prevented, and when the content is the upper limit value or less, there is a tendency that a decrease in stability such as precipitation from the adhesive sheet is easily suppressed, and problems of embrittlement and coloration are easily suppressed.

### Monofunctional (Meth)acrylate

In a case of using a monofunctional (meth)acrylate, preferred compounds, physical properties, and the like are the same as those described for the present adhesive sheet 1.

### Additional Component

As additional components, the same components as those described for the present adhesive sheet 1 can be used.

Among them, in a case of using a silane coupling agent, the content thereof is usually from 0.005 to 5 mass %, preferably from 0.01 to 3 mass %, and more preferably from 0.05 to 1 mass %, with respect to the acrylic adhesive layer (syrup composition). When the content is within the above range, the adhesive force and durability tend to be improved.

A syrup component constituting the syrup composition in the present adhesive sheet 2 may be constituted of the acrylic polymer (A) and a monomer component. In one example, such a syrup component may be formed by so-called partial polymerization of a monomer component, or may be prepared by adding a monomer component to a polymer obtained by completely polymerizing or partially polymerizing a monomer component constituting the acrylic polymer (A). That is, when a predetermined copolymerization component is partially polymerized, some monomers are polymerized to form an oligomer or a polymer, and some monomers remain, whereby a syrup component may be formed. In another example, a syrup can be formed by adding a monomer component to a partially polymerized or completely polymerized polymer.

Accordingly, the monomer unit constituting the acrylic adhesive layer in the present specification may mean a monomer present in a state where an oligomer or a polymer is formed in the components of the acrylic polymer, or a monomer contained in the syrup component before polymerization.

### Method for Producing Present Adhesive Sheet 2

Next, a method for producing the present adhesive sheet 2 will be described.

However, the following description is an example of the method for producing the present adhesive sheet 2, and the present adhesive sheet 2 is not limited to one produced by such a production method.

In the production of the present adhesive sheet 2, usually, the alkyl (meth)acrylate (a1) having an alkyl group with 3 to 30 carbon atoms, the hydroxyl group-containing monomer (a2), and as necessary, the copolymerizable monomers (a3) to (a10), the photoinitiator (C), and the like are mixed to prepare a syrup composition. Next, the syrup composition is irradiated with an active energy ray to perform pre-polymerization. Thereafter, the syrup composition to which the additional photoinitiator (C), the crosslinking agent (B), and additional components are added as necessary is coated on a release film or the like by using various coating methods, and further, the syrup composition is cured by irradiation with an active energy ray or heating, whereby the present adhesive sheet 2 can be obtained.

The crosslinking agent and additional components may be added to the syrup composition from the beginning, or may be added to the syrup composition after the pre-polymerization is completed. Furthermore, the pre-polymerization and the curing may be performed in one process.

In another embodiment of the method for producing the present adhesive sheet 2, the present adhesive sheet 2 can be formed by dissolving the syrup composition in a solvent, coating the dissolved syrup composition on a release film, drying the coated syrup composition, and performing pre-polymerization and curing by irradiation with an active energy ray.

In the method for producing the present adhesive sheet 2, the release film, the active energy ray, the solvent, and the like, the mixing method, the coating method, the drying conditions, and the like are in accordance with the description for the present adhesive sheet 1.

The present adhesive sheet 2 thus obtained may be a single-layer sheet having only an acrylic adhesive layer, or may be a multilayer sheet in which the acrylic adhesive layer or another adhesive layer is laminated in a plurality of layers. The preferred layer configuration and thickness are the same as those of the present adhesive sheet 1. The present adhesive sheet 2 can also be provided as an adhesive sheet with a release film having a configuration in which a release film is laminated on one surface or both surfaces of the adhesive layer (the present adhesive sheet) formed of the adhesive composition.

### Preferred Use of Present Adhesive Sheet

The present adhesive sheets 1 and 2 are suitably used for bonding of an optical member. Specifically, the adhesive sheet is suitably used for bonding members constituting a display, particularly members used for producing a display, and is suitably used as an adhesive sheet for bonding an image display panel and an image display device constituent member such as a protection panel or a touch panel disposed on the front side (viewing side) thereof, or a member constituting the image display device constituent member.

Note that the same image display device constituent member as that described below can be used.

### Laminate for Image Display Device

A laminate for an image display device according to an example of an embodiment of the present disclosure (hereinafter sometimes referred to as “present laminate for an image display device”) is a laminate for an image display device having a configuration in which two image display device constituent members are laminated via the present adhesive sheet. The present laminate for an image display device is preferably a laminate for an image display device having a configuration in which two image display device constituent members are laminated via the present adhesive sheet.

Among constituent elements of the present laminate for an image display device, the present adhesive sheet is as described above, and elements other than the adhesive sheet will be described below.

### Image Display Device Constituent Member

Examples of the image display device constituent member constituting the present laminate for an image display device include a flat panel image display device constituent member, an image display device constituent member having a curved portion, and a flexible image display device constituent member. Examples of such an image display device constituent member include an image display panel such as a liquid crystal display or an organic electroluminescence (EL) display, a surface protection panel (surface protection film), a polarizing plate, a polarizing element, a retardation film, a color filter, a barrier film, a viewing angle compensation film, a brightness enhancement film, a contrast enhancement film, a diffusion film, a semi-transmissive reflection film, an electrode film, a transparent conductive film, a metal mesh film, and a touch sensor film. Any one of these or a combination of two of these is used. For example, a combination of a surface protection panel and another image display device constituent member, or a combination of a surface protection panel and other image display device constituent members, can be mentioned.

It is preferable that one of the two image display device constituent members is a surface protection panel, and the other is a member formed of any one or a combination of two or more selected from the group consisting of a touch sensor film, an image display panel, a color filter, a polarizing element, and a retardation film, and it is more preferable that the surface protection panel has a frame-shaped concealing portion in a peripheral edge thereof, and has a portion where a width of the frame is 3 mm or less. With the above configuration, the effects of the present disclosure can be particularly exhibited. From such a viewpoint, the width of the frame is particularly preferably 2 mm or less, and especially preferably 1.5 mm or less.

The present laminate for an image display device is preferably fixed in a state of having a curved surface shape. The present adhesive sheet is also excellent in bonding reliability to a curved portion, and thus the effects of the present disclosure can be particularly exhibited with the above configuration.

### Method for Producing Present Laminate for Image Display Device

The method for producing the present laminate for an image display device is not particularly limited, and as described above, for example, the adhesive composition may be applied onto the image display device constituent member to form the adhesive sheet, or an adhesive sheet with a release film may be formed in advance and then bonded to the image display device constituent member.

### Image Display Device

An image display device according to an example of an embodiment of the present disclosure (hereinafter sometimes referred to as “present image display device”) is an image display device in which a laminate for an image display device having a configuration in which two image display device constituent members are bonded to each other via the present adhesive sheet is incorporated. For example, there can be exemplified an image display device having a structure obtained by combining a laminate for an image display device having a configuration in which two image display device constituent members are bonded to each other via the present adhesive sheet, and another image display device constituent member.

In this case, examples of the “other image display device constituent member” include an FPC cable, a reflection sheet, a light guide plate and a light source, a diffusion film, a prism sheet, a liquid crystal panel, an organic EL panel, an anti-reflection film, a color filter, a polarizing plate, a retardation plate, a glass substrate, a surface protection film, and a composite integrated body of these members.

Specific examples of the present image display device include a liquid crystal display, an organic EL display, an inorganic EL display, an electronic paper, a plasma display, and a microelectromechanical system (MEMS) display used in a personal computer, a portable terminal, a game machine, a television (TV), a car navigation system, a touch panel, a pen tablet, and the like.

### EXAMPLES

Hereinafter, the present disclosure will be more specifically described with reference to examples, but the present disclosure is not limited to the examples below as long as the gist of the present disclosure is not deviated.

Prior to the examples, the following raw materials were prepared.

### Acrylic Polymer (A)

Acrylic polymers (A-1) to (A-3) having copolymerization component compositions and weight average molecular weights (Mw) as shown in Table 1 below were prepared.

TABLE 1

| | | Constituent unit [mass %] | | | | | | | Weight average |
|---|---|---|---|---|---|---|---|---|---|
| | | EHA | MA | EHMA | IBXA | HEA | AAm | NVP | molecular weight |
| [symbol] lic | (A-1) | 46 | 46 | — | — | — | — | 8 | 250000 |
| [symbol] mer | (A-2) | 44 | — | 18.5 | 21 | 15 | 1.5 | — | 250000 |
| [symbol] ) | (A-3) | 64 | 19 | — | — | 17 | — | — | 460000 |

[symbol]

: 2-ethylhexyl acrylate, MA: methyl acrylate, EHMA: 2-ethylhexyl [symbol] acrylate, IBXA: isobornyl acrylate, HEA: 2-hydroxyethyl acrylate, AAm: [symbol] amide, NVP: N-vinylpyrrolidone, [symbol]
indicates data missing or illegible when filed

Constituent unit [mass %] Weight average molecular weightEHAMAEHMAIBXAHEAAAmNVPAcrylic polymer (A)(A-1)4646----8250000(A-2)44-18.521151.5-250000(A-3)6419--17--460000EHA: 2-ethylhexyl acrylate, MA: methyl acrylate, EHMA: 2-ethylhexyl methacrylate, IBXA: isobornyl acrylate, HEA: 2-hydroxyethyl acrylate,
AAm: acrylamide, NVP: N-vinylpyrrolidone, Constituent unit [mass %] Weight average molecular weightEHAMAEHMAIBXAHEAAAmNVPAcrylic polymer (A)(A-1)4646----8250000(A-2)44-18.521151.5-250000(A-3)6419--17--460000EHA: 2-ethylhexyl acrylate, MA: methyl acrylate, EHMA: 2-ethylhexyl methacrylate, IBXA: isobornyl acrylate, HEA: 2-hydroxyethyl acrylate,
AAm: acrylamide, NVP: N-vinylpyrrolidone,

### Crosslinking Agent (B)

(B-1): Polypropylene glycol #400 diacrylate (“NK Ester APG-400” available from SHIN-NAKAMURA CHEMICAL Co., Ltd.)
(B-2): Hexanediol diacrylate
(B-3): Propoxylated pentaerythritol tri- and tetraacrylate (“NK Ester ATM-4PL” available from SHIN-NAKAMURA CHEMICAL Co., Ltd.)

### Photoinitiator (C)

(C-1): Methyl benzoyl formate (“Omnirad MBF” available from IGM Resins B.V.)
(C-2): 4-Methacryloyloxybenzophenone (“MBP” available from Shinryo Corporation)
(C-3): 4-Acryloyloxybenzophenone (available from Sino-Biochemical Laboratory Co., Ltd.)
(C-4): Benzyldimethylketal (“Omnirad 651” available from IGM Resins B.V.)
(C-5): Mixture of 2,4,6-trimethylbenzophenone and 4-methylbenzophenone (“Esacure TZT” available from IGM Resins B.V.)

### Additional Component

Silane coupling agent: 3-glycidyloxypropyltrimethoxysilane (“KBM403” available from Shin-Etsu Chemical Co., Ltd.)

### Example 1

100 parts by mass of the (meth)acrylic polymer (A-1), 1.5 parts by mass of the crosslinking agent (B-1), 2.45 parts by mass of the photoinitiator (C-1), 1.05 parts by mass of the photoinitiator (C-2), and 0.2 parts by mass of the silane coupling agent were uniformly mixed to prepare an adhesive composition.

Next, the adhesive composition was spread in a sheet shape on a release film (PET film available from Mitsubishi Chemical Corporation) having a thickness of 100 μm and subjected to a silicone release treatment in such a manner that the thickness of the adhesive composition was 150 μm. In addition, a release film (PET film available from Mitsubishi Chemical Corporation) having a thickness of 75 μm and subjected to the silicone release treatment was laminated on the sheet-shaped adhesive composition.

Thereafter, both surfaces of the sheet-shaped adhesive composition were irradiated with an active energy ray through the release films using a high-pressure mercury lamp in such a manner that the cumulative light quantity of a wavelength of 365 nm was 2250 mJ/cm², thereby obtaining an adhesive sheet with a release film composed of release film/adhesive sheet/release film.

### Examples 2 to 4

An adhesive sheet with a release film was produced in the same manner as in Example 1 except that the formulation, the thickness, and the cumulative light quantity were changed to those shown in Table 2 below.

### Example 5

100 parts by mass of the acrylic polymer (A-1), 1.5 parts by mass of the crosslinking agent (B-1), 2.45 parts by mass of the photoinitiator (C-1), 1.05 parts by mass of the photoinitiator (C-2), and 0.2 parts by mass of the silane coupling agent were prepared and uniformly mixed to obtain an adhesive composition for front and back layers.

On the other hand, 100 parts by mass of the acrylic polymer (A-3), 1.5 parts by mass of the crosslinking agent (B-1), 1.75 parts by mass of the photoinitiator (C-1), and 0.75 parts by mass of the photoinitiator (C-2) were prepared and uniformly mixed to obtain an adhesive composition for an intermediate layer.

The adhesive composition for the front and back layers and the adhesive composition for the intermediate layer were supplied to two extruders, respectively, and were coextruded in a layer configuration of two types and three layers (outermost layer/intermediate layer/backmost layer, thickness ratio of 1:2:1) and hot-melt molded into a sheet shape having a thickness of 150 μm.

Next, the sheet-shaped adhesive composition was sandwiched between two polyethylene terephthalate films (PET film available from Mitsubishi Chemical Corporation, thickness: 100 μm, PET film available from Mitsubishi Chemical Corporation, thickness: 75 μm) whose surfaces were subjected to a silicone release treatment, that is, two release films, thereby obtaining a laminate composed of release film/adhesive composition/release film.

Thereafter, both surfaces of the sheet-shaped adhesive composition were irradiated with an active energy ray through the release films using a high-pressure mercury lamp in such a manner that the cumulative light quantity of a wavelength of 365 nm was 2250 mJ/cm², thereby obtaining an adhesive sheet with a release film composed of release film/adhesive sheet/release film.

### Comparative Example 1

An adhesive sheet with a release film was produced in the same manner as in Example 1 except that the formulation, the thickness, and the cumulative light quantity were changed to those shown in Table 2 below.

TABLE 2

| | | | | | | | Example 5 | | Comparative |
|---|---|---|---|---|---|---|---|---|---|
| | | | Example 1 | Example 2 | Example 3 | Example 4 | Front and | Intermediate | Example 1 |
| | | | Monolayer | Monolayer | Monolayer | Monolayer | back layers | layer | Monolayer |
| [symbol] hesive | Acrylic | A-1 | 100 | 100 | — | — | 100 | — | 100 |
| [symbol] position | polymer (A) | A-2 | — | — | 100 | — | — | — | — |
| | [parts by mass] | A-3 | — | — | — | 100 | — | 100 | — |
| | Crosslinking | B-1 | 1.5 | 1.5 | — | — | 1.5 | 1.5 | 1.5 |
| | agent (B) | B-2 | — | — | 0.1 | — | — | — | — |
| | [parts by mass] | B-3 | — | — | — | — | — | — | — |
| | Photoinitiator | C-1 | 2.45 | 1.75 | — | — | 2.45 | 1.75 | 1.75 |
| | (C) | C-2 | 1.05 | 0.75 | — | — | 1.05 | 0.75 | 0.75 |
| | [parts by mass] | C-3 | — | — | 4 | — | — | — | — |
| | | C-4 | — | — | 0.3 | — | — | — | — |
| | | C-5 | — | — | — | 1 | — | — | — |
| | Silane coupling agent | | 0.2 | 0.2 | 0.1 | — | 0.2 | — | 0.2 |
| | [parts by mass] | | | | | | | | |
| [symbol] hesive | Cumulative | mJ/cm² | 2250 | 12250 | 3000 | 1000 | 2250 | | 1500 |
| [symbol] sheet | light quantity | | | | | | | | |

| | | | | | | | |
|---|---|---|---|---|---|---|---|
| Thickness | μm | 150 | 150 | 150 | 150 | 150 | 150 |

| Layer configuration | — | — | — | — | 1:2:1 | — |
|---|---|---|---|---|---|---|
| (Outermost | | | | | | |
| layer:intermediate | | | | | | |
| layer:back most layer) | | | | | | |

[symbol]

indicates data missing or illegible when filed

### Measurement and Evaluation of Physical Properties

The adhesive sheets produced in Examples and Comparative Examples were subjected to the following various measurements and evaluations. The evaluation results are summarized in Table 3 below.

### Shear Storage Modulus of Elasticity at 25° C. (G′)

The release film on one side was removed from the adhesive sheet with a release film produced in each of the Examples and Comparative Examples, and the adhesive sheet was repeatedly laminated with a hand roller to adjust the thickness to about 0.8 mm, and was punched out in a circular shape having a diameter of 8 mm to obtain a sample. The obtained sample was placed in a rheometer (“DHR-2” available from T.A. Instruments), and dynamic viscoelasticity measurement was performed under conditions of a measuring jig: a parallel plate with a diameter of 8 mm, a frequency: 1 Hz, a measurement temperature: −50 to 150° C., and a temperature rise rate: 5° C./min, and the value of shear storage modulus of elasticity at 25° C. (G′) was read.

### Glass Transition Temperature

The release film on one side was removed from the adhesive sheet with a release film produced in each of the Examples and Comparative Examples, and the adhesive sheet was repeatedly laminated with a hand roller to adjust the thickness to about 0.8 mm, and was punched out in a circular shape having a diameter of 8 mm to obtain a sample. The obtained sample was placed in a rheometer (“DHR-2” available from T.A. Instruments), and dynamic viscoelasticity measurement was performed under conditions of a measuring jig: a parallel plate with a diameter of 8 mm, a frequency: 1 Hz, a measurement temperature: −50 to 150° C., and a temperature rise rate: 5° C./min. Then, the glass transition temperature (Tg) defined by the maximum value of Tan δ as obtained by the dynamic viscoelasticity measurement in a shear mode at a frequency of 1 Hz was determined.

### Stress Relaxation Rate

The release film on one side was removed from the adhesive sheet with a release film produced in each of the Examples and Comparative Examples, and the adhesive sheet was repeatedly laminated with a hand roller to adjust the thickness to about 0.8 mm, and was punched out in a circular shape having a diameter of 8 mm to obtain a sample.

A strain of 25% was applied to the obtained sample at 70° C. using a viscoelasticity measurement apparatus (“DHR2” available from T.A. Instruments), and the storage modulus of elasticity after 0.1 seconds had elapsed was read as an initial modulus of elasticity (G′(0)). Further, a strain of 25% was applied at a temperature of 70° C., and the storage modulus of elasticity after 300 seconds had elapsed was read as a relaxation modulus of elasticity (G′(300)). The values of the initial modulus of elasticity (G′(0)) and the relaxation modulus of elasticity (G′(300)) were substituted into the following equation (I) to determine a stress relaxation rate.

$$Stress relaxation rate = ( {G}^{′} ( 300 ) / {G}^{′} ( 0 ) ) \qquad ( I )$$

### Gel Fraction

For the adhesive sheet with a release film produced in each of the Examples and Comparative Examples, an adhesive sheet piece of about 0.1 g was collected from the adhesive sheet from which the release film was peeled off. The collected adhesive sheet piece was wrapped in a SUS mesh (#150) having a mass (X) which had been formed into a bag in advance, the mouth of the bag was closed to prepare a sample, and a mass (Y) of the sample was measured. The sample was stored in a dark place at 23° C. for 24 hours in a state of being immersed in ethyl acetate, then the sample was taken out and heated at 70° C. for 4.5 hours to evaporate ethyl acetate, and the mass (Z) of the dried sample was measured. The gel fraction before active energy ray irradiation was calculated by substituting the measured masses into the following equation (2).

$$Gel fraction ( \% ) = [ ( Z - X ) / ( Y - X ) ] \times 100 \qquad ( 2 )$$

### Adhesive Force

The release film on one side was removed from the adhesive sheet with a release film produced in each of the Examples and Comparative Examples, and a PET film (available from TOYOBO Co., Ltd., COSMOSHINE A4300, thickness: 100 μm) was attached as a backing film with a hand roller. The laminate was cut into a strip of 10 mm wide×150 mm long, and the surface of the adhesive sheet exposed by peeling off the remaining release film was bonded to the surface of soda-lime glass with a hand roller. The obtained laminate was subjected to an autoclaving treatment (60° C., gauge pressure: 0.2 MPa, 20 minutes) for finish bonding, thereby preparing a sample for measuring the adhesive force.

The adhesive sheet was peeled off from the soda-lime glass together with the backing film while pulling the obtained sample for measuring the adhesive force at an angle of 180° and a peeling rate of 60 mm/min under conditions of 23° C. and 50% RH, and the tensile strength (N/cm) was measured with a load cell to obtain the adhesive force.

### Adhesive Overflow Distance

The release film on one side of the adhesive sheet with a release film produced in each of the Examples and Comparative Examples was peeled off, and the remaining adhesive sheet with a release film was half-cut into 10 mm×10 mm. The exposed adhesive surface and soda-lime glass having a thickness of 0.6 mm were faced to each other, and the adhesive sheet and the glass were press-bonded at a temperature of 23° C., a gauge pressure of 0.4 MPa, and a pressing time of 60 seconds using a vacuum bonding machine.

The distance of the adhesive overflowing from the half-cut marked line was measured at the center of each side of the adhesive sheet, and the average value of four sides was taken as the adhesive overflow distance (μm).

### Foaming Resistance (Edge Bubble)

The adhesive sheet with a release film produced in each of the Examples and Comparative Examples was cut into a piece of 45 mm×45 mm. The release film on one side of the cut adhesive sheet was removed, and the exposed adhesive surface was roll-pressed to soda-lime glass (54 mm×82 mm×thickness of 0.6 mm).

Then, the remaining release film was peeled off, and a polarizing plate (54 mm×82 mm×thickness of 0.1 mm) was roll-bonded, and then subjected to an autoclaving treatment (temperature: 60° C., gauge pressure: 0.2 MPa, 8 minutes) for finish bonding, thereby preparing a sample for evaluation of foaming resistance (edge bubble). Eight evaluation samples were prepared for each Example.

Each of the prepared samples was allowed to stand under the environment of 23° C. and 50% RH for 24 hours, and then visually observed to confirm the number of air bubbles generated within 1 mm from the end portion of the adhesive sheet to determine the average value of the number of air bubbles at the end portion per sample.

It was determined as “⊚ (very good)” when no air bubble was confirmed, the average number of air bubbles of 10 or less was determined as “o (good)”, and the average number of air bubbles of more than 10 was determined as “x (poor)”.

TABLE 3

| | | | | | | | | | Comparative |
|---|---|---|---|---|---|---|---|---|---|
| | | | | Example 1 | Example 2 | Example 3 | Example 4 | Example 5 | Example 1 |
| Adhesive | Cumulative light | | mJ/cm² | 2250 | 12250 | 3000 | 1000 | 2250 | 1500 |
| sheet | quantity | | | | | | | | |
| | Thickness | | μm | 150 | 150 | 150 | 150 | 150 | 150 |
| | Layer configuration (outermost | | | Monolayer | Monolayer | Monolayer | Monolayer | 1:2:1 | Monolayer |
| | layer:intermediate | | | | | | | | |
| | layer:backmost layer) | | | | | | | | |
| | Shear storage modulus | | kPa | 215 | 250 | 178 | 93 | 126 | 214 |
| | of elasticity at 25° C. (G′) | | | | | | | | |
| | Glass transition | | ° C. | 2 | 2 | 2 | −22 | −21 | 1 |
| | temperature | | | | | | | | |
| | Initial modulus of | | kPa | 18 | 33 | 16 | 13 | 25 | 44 |
| | elasticity (G′(0)) | | | | | | | | |
| | Relaxation modulus of | | kPa | 8.6 | 20 | 6.6 | 2.4 | 14.2 | 9.9 |
| | elasticity (G′(300)) | | | | | | | | |
| | Stress relaxation rate | | — | 0.47 | 0.6 | 0.40 | 0.25 | 0.56 | 0.22 |
| | Gel Fraction | | % | 79 | 84 | 72 | 54 | 83 | 71 |
| | Adhesive force | | N/cm | 13 | 11 | 12 | 3.5 | 11 | 14 |
| | Adhesive overflow | | μm | 62 | 51 | 96 | 95 | 104 | 68 |
| | distance | | | | | | | | |
| | Foaming | End portion | Number/ | 0 | 0 | 1 | 2 | 0 | 18 |
| | resistance | air bubble | sheet | | | | | | |
| | | number | | | | | | | |
| | | Evaluation | — | ⊚ | ⊚ | ◯ | ◯ | ⊚ | X |

The adhesive sheets of the Examples had a stress relaxation rate of 0.25 or more, and were excellent in foaming resistance at the end face. Among them, Example 1, Example 2, and Example 5 which had a stress relaxation rate of more than 0.45 were particularly excellent in foaming resistance.

On the other hand, the adhesive sheet of Comparative Example 1 had a low stress relaxation rate and was inferior in foaming resistance of the end face.

Specific embodiments of the present disclosure were described in the above examples, but the above examples are merely illustrative and are not to be construed as limiting. Various modifications apparent to those skilled in the art are intended to be within the scope of the present disclosure.

### INDUSTRIAL APPLICABILITY

The adhesive sheet of the present disclosure is excellent in bonding property and can be bonded without air bubbles up to the peripheral edge near the end face of the adhesive sheet. Accordingly, the adhesive sheet can be suitably used as an adhesive sheet used for an image display device, particularly an image display device having a narrow frame design or a frameless design.

1. An adhesive sheet comprising:
an acrylic adhesive layer,
wherein a stress relaxation rate is 0.25 or more, and
wherein the stress relaxation rate is calculated by the following equation (I) from an initial modulus of elasticity (G′(0)) at 0.1 seconds after application of a strain of 25% to the acrylic adhesive layer at a temperature of 70° C. and a relaxation modulus of elasticity (G′(300)) at 300 seconds after application of a strain of 25% to the acrylic adhesive layer at a temperature of 70° C.:
Stress relaxation rate=(G′(300)/G′(0)) (I).

2. The adhesive sheet of claim 1, wherein the acrylic adhesive layer is formed of an adhesive composition comprising an acrylic polymer (A).

3. The adhesive sheet of claim 1,
wherein the acrylic adhesive layer is a cured reaction product of a syrup composition comprising an alkyl (meth)acrylate (a1) having an alkyl group with 3 to 30 carbon atoms, and a hydroxyl group-containing monomer (a2).

4. The adhesive sheet according to claim 1, wherein the initial modulus of elasticity (G′(0)) is from 5 to 100 kPa.

5. The adhesive sheet according to claim 1, wherein the relaxation modulus of elasticity (G′(300)) is from 1.3 to 100 kPa.

6. The adhesive sheet according to claim 1, wherein the adhesive sheet has a gel fraction of 30 to 95%.

7. The adhesive sheet according to claim 1, wherein a storage modulus of elasticity at a temperature of 25° C. (G′(25° C.)) as obtained by dynamic viscoelasticity measurement in a shear mode at a frequency of 1 Hz is 80 kPa or more.

8. The adhesive sheet according to claim 1, wherein a glass transition temperature (Tg) defined by a maximum value of Tan δ as obtained by dynamic viscoelasticity measurement in a shear mode at a frequency of 1 Hz is −20° C. or higher.

9. The adhesive sheet according to claim 1, wherein the adhesive sheet is a monolayer.

10. The adhesive sheet according to claim 2, wherein the adhesive composition comprises a crosslinking agent (B) and a photoinitiator (C).

11. The adhesive sheet according to claim 10, wherein the photoinitiator (C) comprises a photoinitiator (c1) having a radically polymerizable functional group having a carbon-carbon double bond and a structure that generates a radical in a molecule, and a hydrogen abstraction type photoinitiator (c2) other than the photoinitiator (c1).

12. An adhesive sheet with a release film, the adhesive sheet comprising: the adhesive sheet according to claim 1; and a release film laminated on the adhesive sheet.

13. A laminate for an image display device, the laminate comprising: two image display device constituent members; and the adhesive sheet according to claim 1 is interposed between the two image display device constituent members, wherein one of the two image display device constituent members is a surface protection panel, and the other is a member formed of any one or a combination of two or more of the group consisting of a touch sensor film, an image display panel, a color filter, a polarizing element, and a retardation film.

14. The laminate for an image display device according to claim 13, wherein the surface protection panel comprises a concealing portion having a frame shape in a peripheral edge thereof, and includes a portion in which a frame width of the concealing portion is 3 mm or less.

15. The laminate for an image display device according to claim 13, wherein the laminate is fixed in a state of having a curved face shape.

16. An image display device comprising the laminate for an image display device according to claim 13.

17. An adhesive sheet for an image display device constituent member, the adhesive sheet comprising the adhesive sheet according to claim 1.
